(19) United States
(12) Patent Application Publication
(10) Pub. No.: US 2024/0343856 A1
(43) Pub. Date: Oct. 17, 2024

(54) AQUEOUS POLYURETHANE-VINYL POLYMER HYBRID DISPERSION

(71) Applicant: Allnex Austria GmbH, WERNDORF (AT)

(72) Inventors: Andreas J. STEINER, Graz (AT); Ulrike Elfriede KUTTLER, Vasoldsberg (AT); Anton ARZT, Tillmitsch (AT); Robert HARRER, Graz (AT)

(73) Assignee: Allnex Austria GmbH, WERNDORF (AT)

(21) Appl. No.: 18/576,258

(22) PCT Filed: Jul. 5, 2022
(86) PCT No.: PCT/EP2022/068586

§ 371 Date: Jan. 3, 2024

(30) Foreign Application Priority Data
Jul. 6, 2021 (EP) 21183869.3

(51) Int. Cl. C08G 18/72; C08G 18/08; C08G 18/12; C08G 18/32; C09D 5/08; C09D 175/04

(52) U.S. Cl. CPC C08G 18/722; C08G 18/0823; C08G 18/0866; C08G 18/12; C08G 18/3271; C08G 18/728; C09D 5/08; C09D 175/04; C08G 2150/90

(57) ABSTRACT

The present invention relates to aqueous polyurethane-vinyl polymer hybrid dispersions which are prepared by polymerisation, initiated by free radicals, of ethylenically unsaturated monomers and polyurethane prepolymers containing acid groups and hydroxyl groups, to a method for their preparation, and to their use particularly as coating binder in multilayer coatings.

### FIELD OF THE INVENTION

The present invention relates to aqueous polyurethane-vinyl polymer hybrid dispersions which are prepared by polymerisation, initiated by free radicals, of ethylenically unsaturated monomers and polyurethane prepolymers containing (pendant) acid groups and hydroxyl groups, to a method for their preparation, and to their use, particularly as coating binder in multilayer coatings.

Dispersions of polyurethane-vinyl polymer hybrids made by radically initiated copolymerisation of ethylenically unsaturated monomers and polyurethane macromonomers have been known in the art.

EP 0522420 A2 discloses polyurethane dispersions prepared by free radical-initiated polymerisation of polyurethane macromonomers containing carboxyl, phosphonyl or sulphonyl groups and terminal vinyl groups and optionally urethane, thiourethane or urea groups, where the terminal vinyl groups are not derived from hydroxyalkyl (meth)acrylates.

EP 1173491 B1 discloses a polymer obtainable by a multistage polymerization process which involves conducting, in a first step, an aqueous-phase polymerization of at least one ethylenically monofunctional compound alone or together with at least one ethylenically difunctional or poly-functional compound together in the presence of a polyesterpolyol, polyurethane and/or polyacrylate; followed by a reaction of the resulting product with a crosslinker.

EP 1185568 B1 discloses a polymer obtained in a multi-stage polymerisation process. In the first stage, polymerisation is carried out in the aqueous phase of at least one ethylenically monofunctional compound, optionally with at least one ethylenically difunctional or multifunctional compound in the presence of a polyesterpolyol, polyurethane and/or a polyacrylate; in the following stage, the resulting product is reacted with at least one ethylenically monofunctional compound, optionally with at least one ethylenically difunctional or multifunctional compound; the resulting product is subsequently reacted with a cross-linking agent. EP 1185568 B1 also relates to the utilization of said polymer.

EP 1391471 B1 discloses a process for preparing aqueous, polyurethane-polyacrylate hybrid dispersions, comprising the steps of
(I) preparing a hydrophilic or hydrophilicizable polyurethane by reacting one or more isocyanate components (A) with one or more components (B) comprising
   (B1) one or more diols or polyols having a molecular weight of from 500 to 6000 and an OH functionality of from 1.8 to 5;
   (B2) one or more low molecular weight diols or polyols of the molecular weight range from 62 to 400 with an OH functionality of two or more as chain extenders;
   (B3) one or more hydrophilic compounds containing non-ionic groups and/or ionic and/or potentially ionic groups and having at least one NCO-reactive group;
   (B4) optionally one or more polyamines and/or alkanolamines with molecular weights in the range from 60 to 300 g/mole and NH functionalities greater than or equal to 2;
   (B5) optionally monofunctional compounds with molecular weights in the range from 17 to 350 g/mole;
in the presence of ethylenically unsaturated monomers (C1) which are inert towards NCO groups, with the proviso that components (A) and (B) are used so as to result in a ratio of NCO groups to OH/NH/NH2 groups of 1:1;
(II) subsequently dispersing the polyurethane from (I) in water; and
(III) emulsion-polymerizing monomers (C) comprising one of
   (i) ethylenically unsaturated monomers (C1) inert towards NCO groups and
   (ii) ethylenically unsaturated monomers (C1) inert towards NCO groups and ethylenically unsaturated monomers (C2) containing Zerevitinov-active hydrogen atoms.

EP 1497349 B1 discloses an aqueous polyurethane dispersion, comprising polyurethane-acrylate particles dispersed in an aqueous medium, said particles comprising the reaction product obtained by polymerizing the components of a pre-emulsion formed from:
(A) an active hydrogen-containing polyurethane acrylate prepolymer, comprising a reaction product obtained by reacting:
   (i) a polyol;
   (ii) a polymerizable ethylenically unsaturated monomer containing at least one hydroxyl group;
   (iii) a compound comprising a C1-C30 alkyl group having at least two active hydrogen-containing groups selected from carboxylic acid groups and hydroxyl groups, wherein at least one active hydrogen-containing group is a hydroxyl group; and
   (iv) a polyisocyanate;
(B) one or more hydrophobic polymerizable ethylenically unsaturated monomers; and
(C) a crosslinking monomer having two or more sites of polymerizable ethylenic unsaturation;
   wherein the active hydrogen-containing polyurethane acrylate prepolymer of (A) includes at least 30 percent by weight of polyurethane acrylate prepolymer comprising one or more prepolymers having at least one terminal polymerizable site of ethylenic unsaturation at one end of the molecule and at least one active hydrogen-containing group at the opposite end of the molecule; and at least 10 percent by weight of the polyurethane acrylate prepolymer comprising one or more prepolymers having at least one terminal polymerizable site of ethylenic unsaturation at each end of the molecule.

EP 2655458 B1 discloses a polyurethane-polyacrylate hybrid dispersion obtainable by two-stage free-radical polymerization of ethylenically unsaturated compounds in the presence of at least one polyurethane (P1), where
in a first stage a monomer mixture (e) of at least one ethylenically unsaturated compound is subjected to at least partial free-radical polymerization in the presence of the at least one polyurethane (P1), at least one redox initiator system (I), and at least one iron compound (F); and subsequently
in a second stage a monomer mixture (f) of at least one ethylenically unsaturated compound is subjected to free-radical polymerization, where
   the at least one polyurethane (P1) is composed exclusively of aliphatic and/or cycloaliphatic isocyanates as isocyanate-group-containing synthesis components and has an at least partially neutralized acid group content of less than 500 mmole per kg of polyurethane;
   the polymerized monomer mixture (e) of the first stage has a glass transition temperature of at least 50° C.;
   the polymerized monomer mixture (f) of the second stage has a glass transition temperature of up to 20° C.;
   the weight ratio of polyurethane (P1) to the sum of the ethylenically unsaturated compounds (e) and (f) of the first and second stages is from 50:50 to 30:70;
   the temperature during the free-radical polymerization is not more than 85° C., and where the glass transition temperature is determined in accordance with ASTM provision D3418-03, via Differential Scanning calorimetry (DSC), with a heating rate of 10° C./min.

EP 3022242 B1 discloses an aqueous dispersion comprising at least one copolymer, the copolymer being preferable by
(i) initially charging an aqueous dispersion of at least one polyurethane, and then
(ii) polymerizing a mixture of olefinically unsaturated monomers in the presence of the polyurethane from (i), where
   (a) a water-soluble initiator is used,
   (b) the metered addition of the olefinically unsaturated monomers is effected such that a concentration of 6.0% by weight, based on the total amount of olefinically unsaturated monomers, in the reaction solution is not exceeded over the entire duration of the reaction, and
   (c) the mixture of the olefinically unsaturated monomers comprises at least one polyolefinically unsaturated monomer.

US 2019169353 A1 discloses aqueous polyurethane-vinyl polymer hybrid dispersions comprising, as building blocks,
hydrophobically modified hydroxy-functional polyesters A,
acids B that have further groups which react with isocyanates under formation of urethanes, ureas, or thiourethanes,
optionally, hydroxy-functional oligomeric or polymeric compounds C which may be polyesters, polycarbonates, polyethers, polyamides, polydienes and polyenes, and which have at least two hydroxyl groups per molecule,
optionally, monomeric hydroxy compounds D having at least two hydroxyl groups per molecule,
optionally, compounds E having at least one primary or secondary amino group, and at least one hydroxyl group per molecule,
optionally, compounds F having two or more primary or secondary amino groups per molecule and no hydroxyl groups,
compounds G having only one hydroxyl group, and one or more tertiary amino groups, olefinically unsaturated monomers H2 having a polymerisable ethylenic unsaturation and a further functional group which reacts with an isocyanate group under bond formation,
olefinically unsaturated monomers H1 having at least one polymerisable ethylenic unsaturation and no further functional group which reacts with an isocyanate group, and
multifunctional isocyanates I having at least two isocyanate groups per molecule,
   wherein the hydrophobically modified polyesters A are obtained from a polyester A′ having residual hydroxyl and acid groups, by reaction of the acid groups thereof with a mono-functional compound A4 having an epoxide or aziridine functionality, and a linear or branched alkyl residue of at least four carbon atoms, in which reaction at least 90% of the remaining acid groups of the polyester A′are converted to ester or amide groups.

### Aim of the Invention

The present invention aims to provide an aqueous dispersion for coating compositions that do not present the limitations of the prior art.

It is the aim of the present invention to provide surfactant-free aqueous polyurethane-vinyl polymer hybrid dispersions with increased solid content compared to the current state in the art systems.

It is a further aim of the present invention to provide aqueous polyurethane-vinyl polymer hybrid dispersions with improved water and humidity resistance and improved interlayer adhesion in multi-layer coating films.

### Summary of the Invention

The present invention discloses an aqueous polyurethane-vinyl polymer hybrid dispersion D comprising the reaction product E of one or more ethylenically unsaturated monomer(s) MU2, the MU2 being polymerized in the presence of polyurethane-vinyl polymer hybrid prepolymer having pendant acid salt groups, PUSpp, said prepolymer PUSpp comprising pendant polyvinyl chains, said prepolymer PUSpp being the reaction product of one or more ethylenically unsaturated monomer(s) MU1 polymerized in the presence of an acid salt groups comprising hydroxyl-functional polyurethane, PUSoh, having pendant ethylenically unsaturated groups and pendant groups of acid salts.

Preferred embodiments of the present invention disclose one or more of the following features:
the hydroxyl-functional polyurethane PUoh is characterized by an unsaturated equivalent weight (UEW) comprised between 3,500 and 35,000 g/equiv., the ethylenically unsaturated groups being pending groups;
the hydroxyl-functional polyurethane PUoh is characterized by an acid number between 30 and 60 mg KOH/g;
the dispersed particles of reaction product E are characterized by a Z-average particle size according to ISO 22412 comprised between 50 and 150 nm;
the aqueous polyurethane-vinyl polymer hybrid dispersion D comprises between 40 and 55% by weight, preferably from 43 to 50% by weight, of solids and between 45 and 60% by weight, preferably between 50 and 57% by weight, of water.

Coating compositions comprising the aqueous polyurethane-vinyl hybrid dispersion D are useful for the production of corrosion preventing coatings, or corrosion preventing multi-coat build-ups, for metal substrates.

Further disclosed is a method for the preparation of the aqueous polyurethane-vinyl polymer hybrid dispersions D, comprising the fast addition of a mixture comprising one or more primary or secondary amine(s) Aoh having at least one hydroxyl group, and optionally and preferably one or more ethylenically unsaturated monomer(s) MU1, to an isocyanate-functional polyurethane prepolymer comprising pendant ethylenically unsaturated groups and pendant acid groups, to form an hydroxyl-functional polyurethane prepolymer PUoh in ethylenically unsaturated monomer(s) MU1; adding neutralizing agent An to form an acid salt groups comprising hydroxyl-functional polyurethane, PUSoh, comprising pendant ethylenically unsaturated groups, in ethylenically unsaturated monomer(s) MU1, adding water to form an emulsion followed by the gradual addition of at least one of a redox system components and polymerizing the emulsion to form PUSpp, which subsequently is further reacted, through a second fast addition of ethylenically unsaturated monomers MU2, to form the aqueous polyurethane-vinyl polymer hybrid dispersion D1, after completing further redox polymerization.

Preferred embodiments of the method of the present invention comprises additional fast addition of a mixture of ethylenically unsaturated monomers MU1 and/or MU2 to the aqueous polyurethane-vinyl polymer hybrid dispersion D1 and redox-polymerizing to form the aqueous polyurethane-vinyl polymer hybrid dispersion D2.

The present invention further discloses a coating composition comprising the aqueous polyurethane-vinyl polymer hybrid dispersion D and one or more additive(s) selected from the group consisting of defoamers, levelling agents, UV-absorbers, coalescing agents, flow modifiers, rheology additives, fillers, pigments, active pigments and wetting agents.

The coating composition can further comprise crosslinkers.

The present invention further discloses the use of said coating composition for coating a metal, wood, plastic or paper substrate, preferably for coating a metal substrate.

### DETAILED DESCRIPTION OF THE INVENTION

In the present invention, it has been found that an aqueous dispersion D of a polyurethane-vinyl polymer hybrid E made by polymerisation, initiated by free radicals, of a mixture of ethylenically unsaturated monomers, MU2, in the presence of a polyurethane-vinyl polymer hybrid prepolymer having pendant acid salt groups, PUSpp, lead to improved basecoat coating compositions.

More particularly, there is provided an aqueous polyurethane-vinyl polymer hybrid dispersion D comprising the reaction product E of one or more ethylenically unsaturated monomer(s) MU2, the MU2 being polymerized in the presence of a polyurethane-vinyl polymer hybrid prepolymer having pendant acid salt groups PUSpp (thereby forming the reaction product E);
said acid salt groups comprising polyurethane-vinyl polymer hybrid prepolymer having pendant acid salt groups, PUSpp, being (in turn) the reaction product of:
   an acid salt groups comprising hydroxyl-functional polyurethane, PUSoh, having pendant ethylenically unsaturated groups and pendant groups of acid salts; and
   one or more ethylenically unsaturated monomer(s) MU1,
the MU1 being polymerized in the presence of the acid salt groups comprising hydroxyl-functional polyurethane PUSoh (thereby forming the polyurethane-vinyl polymer hybrid prepolymer having pendant acid salt groups, PUSpp); said acid salt groups comprising hydroxyl-functional polyurethane, PUSoh, being (in turn) the reaction product of:
   hydroxyl-functional polyurethane PUoh, and
   one or more compound(s) An being able to react with an acid group to form salt groups (thereby forming PUSoh);
said hydroxyl-functional polyurethane PUoh being (in turn) the reaction product of one or more polyisocyanate(s) I and:
   one or more isocyanate-reactive compound(s) having at least two isocyanate-reactive groups selected from the group consisting of monomeric compounds Moh, polymeric compounds Poh and mixtures thereof;
   one or more isocyanate-reactive monomer(s), MAoh, having at least two isocyanate-reactive groups and at least one acid group or group being able to form an acid when contacted with water;
   one or more isocyanate-reactive monomer(s), MUoh, having at least two isocyanate-reactive groups and an ethylenically unsaturated group; and
   one or more primary or secondary amine(s), Aoh, having at least one hydroxyl group.

Preferably the hydroxyl-functional polyurethane PUoh is characterized by a hydroxyl number comprised between 10 and 100 mg KOH/g, more preferably between 15 and 85 mg KOH/g, even more preferably between 20 and 75 mg KOH/g (the amount of ethylenically unsaturated monomer(s) MU1 not taken into account for the determination of the hydroxyl number of said hydroxyl-functional polyurethane PUoh).

It is believed, without being bound by theory, that monomer(s) MU1 co-react with the ethylenically unsaturated groups pending from PUSoh and form a homogeneous polymer phase of polyurethane-vinyl polymer hybrid prepolymer

PUSpp. Other than that, monomer(s) MU2 are copolymerized in the presence of PUSpp and build a separate polymer phase (i.e. a separate polymer phase from the homogeneous polymer phase of polyurethane-vinyl polymer hybrid prepolymer PUSpp).

In the context of the present description, “polyurethane-vinyl polymer hybrid E” is also referred to as “reaction product E”.

In the context of the present description, “PUSpp” refers to “an acid salt groups comprising polyurethane-vinyl polymer hybrid prepolymer”, or in other words, to “a polyurethane-vinyl polymer hybrid prepolymer comprising acid salt groups”. More specifically, “PUSpp” refers to “a polyurethane-vinyl polymer hybrid prepolymer having pendant acid salt groups”.

In the context of the present description, “PUSoh” refers to “an acid salt groups comprising hydroxyl-functional polyurethane, or in other words, to “a hydroxyl-functional polyurethane comprising acid salt groups”, more particularly, “PUSoh” refers to an “acid salt groups comprising hydroxyl-functional polyurethane, having pendant ethylenically unsaturated groups and pendant groups of acid salts (or pendant salt groups)”.

In the context of the present description, “MAoh” refers to an “isocyanate-reactive monomer having at least two isocyanate-reactive groups and at least one acid group or group being able to form an acid when contacted with water”.

In the context of the present description, “MUoh” refers to an “isocyanate-reactive monomer having at least two isocyanate-reactive groups and an ethylenically unsaturated group”.

In the context of the present description, “renewable feedstock” refers to natural resources which will replenish to replace the portion depleted by usage and consumption, either through natural reproduction or other recurring processes (in a finite amount of time in a human time scale). Substances or mixtures of substances obtained from such renewable feedstock should have in total a bio-based carbon content of more than 20% by weight of total carbon content of the substance or mixture, the bio-carbon content being determined using the ASTM D6866-20 standard.

Preferably the ethylenically unsaturated monomers MU2 are selected from the group consisting of mono-ethylenically unsaturated monomers, poly-ethylenically unsaturated monomers and mixtures thereof.

Preferably the ethylenically unsaturated monomers MU2 are esters of (meth)acrylic acid with aliphatic linear, branched or cyclic monoalcohols having from one to twelve carbon atoms in the alkyl group, more preferably being selected from the group consisting of methyl (meth)acrylate, ethyl (meth)acrylate, butyl (meth)-acrylate, hexyl(meth)acrylate, 2-ethylhexyl(meth)acrylate, isobornyl (meth)acrylate and mixtures thereof.

The ethylenically unsaturated monomers MU2 optionally comprise monomers selected from the group consisting of keto-functional (meth)acrylates such as acetoacetoxyethyl methacrylate; hydroxy-functional (meth)acrylates such as hydroxyethyl methacrylate; epoxy-functional (meth)acrylates such as glycidyl methacrylate; (meth)acryl amides such as diacetone acrylamide; and vinyl monomers such as styrene, vinyltoluene, acrylonitrile, methacrylonitrile; and mixtures thereof.

The ethylenically unsaturated monomers MU2 may further comprise up to 10% by weight, of the total amount of ethylenically unsaturated monomers, of poly-ethylenically unsaturated monomers, more particularly, the ethylenically unsaturated monomers MU2 optionally comprise up to 10% by weight, of the total amount of ethylenically unsaturated monomers, of poly-ethylenically unsaturated monomers selected from the group consisting of ethylene glycol di(meth)acrylate, 1,2-propylene glycol di(meth)acrylate, 1,3-propylene glycol di(meth)acrylate, butane-1,4-diol di(meth)acrylate, neopentyl glycol di(meth)acrylate, 3-methylpentanediol di(meth)acrylate, diethylene glycol di(meth)acrylate, triethylene glycol di(meth)acrylate, tetraethylene glycol di(meth)acrylate, dipropylene glycol di(meth)acrylate, tripropylene glycol di(meth)acrylate, hexanediol di(meth)acrylate, allyl(meth)acrylate, trimethylolpropane tri(meth)acrylate, glyceryl tri(meth)acrylate, trimethylolpropane di(meth)acrylate monoallyl ether, trimethylolpropane(meth)acrylate diallyl ether, pentaerythritol tri(meth)acrylate monoallyl ether, pentaerythritol di(meth)acrylate diallyl ether, pentaerythritol(meth)acrylate triallyl ether, triallylsucrose and pentaallylsucrose, and mixtures thereof.

More preferably the ethylenically unsaturated monomers MU2 are selected from the group consisting of alkylacrylates, alkyl(meth)acrylates and mixtures thereof.

The polyurethane-vinyl polymer hybrid prepolymer having pendant acid salt groups, PUSpp, is the reaction product of:
an acid salt groups comprising hydroxyl-functional polyurethane, PUSoh, having pendant ethylenically unsaturated groups and pendant salt groups; and
one or more ethylenically unsaturated monomer(s) MU1, the MU1 being polymerized in the presence of the acid salt groups comprising hydroxyl-functional polyurethane PUSoh;
   wherein the one or more ethylenically unsaturated monomers MU1 are selected from the group consisting of esters of (meth)acrylic acid with aliphatic linear, branched or cyclic monoalcohols having from one to twelve carbon atoms in the alkyl group, keto-functional (meth)acrylates, hydroxy-functional (meth)acrylates, epoxy-functional (meth)acrylates, (meth)acryl amides, vinyl monomers and mixtures thereof.

Preferably the ethylenically unsaturated monomers MU1 are selected from the same group of monomers as those described for MU2 (vide supra) but further excluding for MU1 the optional poly-ethylenically unsaturated monomers listed above for MU2 (i.e. preferably the ethylenically unsaturated monomers MU1 are mono-ethylenically unsaturated monomers).

Further preferably the % by weight of each monomer contained in MU1 is different from the % by weight of the corresponding monomer in MU2, the sum of % by weight of all monomers contained in MU1 being 100% and the sum of % by weight of all monomers contained in MU2 being 100%.

Optionally the ethylenically unsaturated monomers MU1 are selected in such a way that the polyurethane-vinyl polymer hybrid prepolymer having pendant acid salt groups, PUSpp, comprises pendant polymerized ethylenically unsaturated monomers and end-standing polymerized ethylenically unsaturated monomers.

Preferably the ethylenically unsaturated monomers MU1 are selected in such a way that the polyurethane-vinyl polymer hybrid prepolymer having pendant acid salt groups, PUSpp, is substantially free of polyurethane chains having end-standing polymerized ethylenically unsaturated monomers. More preferably the ethylenically unsaturated monomers MU1 are selected in such a way that the polyurethane-vinyl polymer hybrid prepolymer having pendant acid salt groups, PUSpp, comprises 0% end-standing polymerized ethylenically unsaturated monomers.

Alternatively and preferred, where possible, the ethylenically unsaturated monomers MU1 and/or MU2 are obtained from renewable feedstock (i.e. the monomers, such as for example n-heptyl acrylate, isobornyl methacrylate, and/or isobutyl acrylate, are obtained in part or fully from (bio-)renewable sources). The exact amounts of bio-based carbon in these monomers can be determined by the method described in ASTM D6866-20, wherein carbons resulting from contemporary biomass-based inputs are distinguished from those derived from fossil-based inputs, the bio-based carbon content being reported as the fraction of total organic carbon content (TOC). Other standardized methods to determine the fraction of renewable carbon are ISO 16620-2 and CEN 16640.

Another alternative method for reducing the carbon footprint of the present polymer hybrid dispersions is to use recycled monomers for the preparation thereof. Polymers, such as poly(methyl methacrylate) or poly(styrene), can be pyrolyzed at temperatures above their ceiling temperature. By distillation of the pyrolysis products, recycled monomers, such as methyl methacrylate or styrene, can be obtained which can then be further used in the emulsion polymerization for preparing the present polymer dispersions.

In yet another alternative, the ethylenically unsaturated monomers MU1 and/or MU2 are obtained from petrochemical feedstock and/or renewable feedstock, and/or are recycled monomers.

In the context of the present description, “bio-based carbon content” refers to bio-carbon content.

The acid salt groups comprising hydroxyl-functional polyurethane, PUSoh, is the reaction product of:
hydroxyl-functional polyurethane PUoh comprising pendant acid groups or pendant acid group precursors, and pendant ethylenically unsaturated groups; and
one or more neutralizing compound(s) An.

In the context of the present description, “an acid group precursor” refers to a group being able to form an acid when contacted with water.

The one or more neutralizing compound(s) An preferably are selected from the group consisting of primary, secondary and tertiary amines, and strong Arrhenius bases such as the hydroxides of alkali metals and alkaline earth alkali metals.

More preferably the neutralizing compound(s) An are selected from the group consisting of ammonia, and the compounds having not more than one hydroxyl group and at least one tertiary amino group per molecule.

Most preferably the neutralizing compound(s) An are selected from the group consisting of ammonia, N,N-dimethylaminoethanol, 1-dimethylamino-2-propanol, 1-dimethylamino-3-propanol, and also N-(2-hydroxy ethyl)piperazine, and mixtures thereof.

The hydroxyl-functional polyurethane PUoh is the reaction product of one or more polyisocyanate(s) I and:
one or more isocyanate-reactive compounds, Moh and/or Poh, having at least two isocyanate-reactive groups;
one or more isocyanate-reactive monomers, MAoh, having at least two isocyanate-reactive groups and an at least one acid group or an acid group precursor;
one or more isocyanate-reactive monomers, MUoh, having at least two isocyanate-reactive groups and an ethylenically unsaturated group; and
one or more primary or secondary amine(s), Aoh, having at least one hydroxyl group.

The one or more polyisocyanates I are selected from the group consisting of aromatic or aliphatic or mixed aliphatic-aromatic isocyanates, and are preferably selected from the group consisting of trimethylene diisocyanate, tetramethylene diisocyanate, pentamethylene diisocyanate, hexamethylene diisocyanate (HDI), propylene diisocyanate, ethylethylene diisocyanate, 2,3-dimethylethylenediisocyanate, 1-methyltrimethylene diisocyanate, cyclopentylene 1,3-diisocyanate, cyclohexylene 1,4-diisocyanate, cyclohexylene 1,2-diisocyanate, phenylene 1,3-diisocyanate, phenylene 1,4-diisocyanate, toluylene 2,4-diisocyanate, toluylene 2,6-diiso-cyanate, biphenylene 4,4′-diisocyanate, bis-(4-isocyanatophenyl) methane (MDI), naphthylene 1,5-diisocyanate, naphthylene 1,4-diisocyanate, 1-isocyanatomethyl-5-isocyanato-1,3,3-tri-methylcyclohexane (IPDI), bis-(4-isocyanatocyclohexyl)methane (H12-MDI), 4,4′-diiso-cyanato-diphenyl ether, 2,3-bis-(8-isocyanatooctyl)-4-octyl-5-hexylcyclohexene, trimethylhexamethylene diisocyanates, tetramethylxylylene diisocyanates, uretdiones of the above diisocyanates, isocyanurates of the above diisocyanates and allophanates of the above diisocyanates and mixtures thereof.

Alternatively and preferred, where possible, the polyisocyanates I are obtained from renewable feedstock. Particularly preferred is isophorone diisocyanate obtained from bio-based acetone. Other preferred polyisocyanates derived in part from renewable feedstocks are for example 1,5-pentaethylene diisocyanate, diisocyanates of the methyl or ethyl esters of l-lysine, isosorbide-based diisocyanates, furan based diisocyanate, bis(4-isocyanato-2-methoxyphenoxy)alkane, bis(4-isocyanato-2,6-dimethoxyphenoxy) alkane, 2,4-diisocyanato-1-pentadecylbenzene, di-and polyisocyanates based on fatty acids, dimer fatty acids and vegetable oils, 1-isocyanato-10-[(isocyanatomethyl)thio] decane and a product known under the tradename TOLONATE™ X FLO 100.

The isocyanate-reactive compounds having at least two isocyanate-reactive groups are selected from the group consisting of monomeric compounds Moh having at least two isocyanate-reactive groups, polymeric compounds Poh having at least two isocyanate-reactive groups, and mixtures thereof.

Polymeric compounds Poh having at least two isocyanate-reactive groups should be understood as compounds comprising at least two repeating units.

Preferably the polymeric compounds Poh having at least two isocyanate-reactive groups are selected from the group consisting of polyesters, polylactones, polyethers, polycarbonates, polyamides, polyenes, polydienes, and mixtures thereof; more preferably selected from the group consisting of hydroxyl-functional polyesters, hydroxyl-functional polylactones, hydroxyl-functional polyethers, hydroxyl-functional polycarbonates, hydroxyl-functional polyamides, hydroxyl-functional polyenes, hydroxyl-functional polydienes, and mixtures thereof; most preferably selected from the group consisting of hydroxyl-functional polyesters, hydroxyl-functional polycarbonates, hydroxyl-functional polyethers, and mixtures thereof.

Preferably the polymeric compounds Poh are characterized by a Number Average Molecular Weight comprised between 300 and 10,000 g/mole, more preferably between 400 and 8,000 g/mole, most preferably between 500 and 5,000 g/mole, even most preferably between 500 and 3,000 g/mole.

More preferably, the polymeric compounds Poh having at least two isocyanate-reactive groups are selected from the group consisting of hydroxyl-functional polyesters, hydroxyl-functional polycarbonates, hydroxyl-functional polyethers and mixtures thereof; said polymeric compounds Poh being characterized by a Number Average Molecular Weight comprised between 500 and 3,000 g/mole.

Preferably the polymeric compounds Poh having at least two isocyanate-reactive groups are polymeric compounds having at least two hydroxyl groups (more particularly, in the polymeric compounds Poh the at least two isocyanate-reactive groups preferably are at least two hydroxyl groups).

Preferably the polymeric compounds Poh are characterized by an hydroxyl number comprised between 40 and 300 mg KOH/g, even more preferably between 50 and 250 mg KOH/g, most preferably between 70 and 150 mg KOH/g.

More preferably the polymeric compounds Poh having at least two hydroxyl groups are selected from the group consisting of polyesters having at least two hydroxyl groups Poh1, polyethers having at least two hydroxyl groups Poh2, polycarbonates having at least two hydroxyl groups Poh3 and mixtures thereof

More particularly, polymeric compound Poh1 is a hydroxyl-functional polyester, said polyester being the reaction product of a stoichiometric excess of one or more diol(s) and one or more diacid(s), and said polyester being characterized by an hydroxyl number comprised between 40 and 300 mg KOH/g and an acid number of less than 3 mg KOH/g, said acid number being residual and generated by end-standing unreacted acid functionalities.

The polyesters Poh1 having at least two hydroxyl groups preferably have two hydroxyl groups and are prepared from stoichiometric excess of one or more diols and one or more diacids,
said diols being preferably selected from the group consisting of 1,2-ethanediol, 1,2-and 1,3-propanediol, 1,2-and 1,4-butanediol, 2,2′-oxydi(ethan-1-ol), 2,2-dimethyl-1,3-propanediol, 2-methyl-2,4-pentanediol, 1,4-bis-hydroxymethylcyclo-hexane, 1,6-hexanediol, 1,8-octanediol, 1,10-decanediol, 1,12-dodecanediol, 1, 13-tridecanediol, 1,18-octadecanediol, 1,21-heneicosanediol, 1,25-pentacosane diol, isosorbide, isomannide, isoidide and mixtures thereof;
said diacids being preferably selected from the group consisting of malonic acid, succinic acid, glutaric acid, adipic acid, octanedioic acid, and also dimeric fatty acids having up to forty carbon atoms, isophthalic acid, terephthalic acid, naphthalene dicarboxylic acids and mixtures thereof.

Optionally one or more hydroxy-carboxylic acid(s), such as for example hydroxybenzoic acid, lactic acid, gamma-hydroxybutyric acid, delta-hydroxyvaleric acid, and epsilon-hydroxycaproic acid, in combination with one or more diols may be used for the preparation of the hydroxyl-functional polyesters Poh1.

Alternatively and preferred, where possible, said diols (i.e. 1,3-propanediol), diacids (i.e. succinic acid) or hydroxy-carboxylic acid(s) (i.e. lactic acid) used for the preparation of the hydroxyl-functional polyesters Poh1, are obtained from renewable feedstock.

More preferably the polyesters Poh1 are the condensation product of adipic acid and one or more diols selected from the group consisting of 1,4 butanediol, 1,6-hexanediol and 2,2-dimethyl-1,3-propanediol, said polyesters being characterized by a hydroxyl number comprised between 40 and 300 mg KOH/g, even more preferably between 40 and 150 mg KOH/g, and an acid number of less than 3 mg KOH/g, preferably less than 2 mg KOH/g, more preferably less than 1 mg KOH/g, said acid number being residual and generated by end-standing unreacted acid functionalities.

The hydroxyl-functional polyester Poh1 having two hydroxyl groups should be understood as a polyester having almost two hydroxyl groups and a negligible amount of carboxylic acid groups, since a 100% conversion is hardly to achieve.

The polyesters Poh1 having two hydroxyl groups do not comprise carboxylic acid side groups, provided by co-condensation of hydroxyl-functional monomers having at least two hydroxyl groups and at least one carboxylic acid group (MAoh) (or in other words, the polyesters Poh1 having two hydroxyl groups comprise 0% carboxylic acid side groups provided by co-condensation of hydroxyl-functional monomers MAoh having at least two hydroxyl groups and at least one carboxylic acid group).

The polyesters Poh1 in the present invention thus are prepared from a stoichiometric excess of diols over diacids, said diols excluding compounds having at least two hydroxyl groups and at least one carboxylic acid group (MAoh) such as 2,2-(bis-hydroxymethyl)acetic acid, 2,2-(bishydroxymethyl)-propionic acid or 2,2-(bishydroxymethyl) butyric acid.

The polyether compounds Poh2 preferably are poly(oxyalkylene)glycols comprising between 2 and 6 alkylradicals, more preferably the polyethers Poh2 are selected from the group consisting of poly(oxyethylene)glycol, poly(oxypropylene)glycol, poly(oxytetramethylene)glycol and mixtures thereof.

Alternatively and preferred, where possible, polyether compounds Poh2 are poly(oxyalkylene)glycols obtained from renewable feedstock, more preferably they are poly(oxyalkylene)glycol obtained from bio-based 1,3-propandiol.

The polycarbonate compounds Poh3 preferably are prepared by reaction of polyols, such as 1,3-propanediol, 1,4-butanediol, 1,6-hexanediol, diethylene glycol, triethylene glycol, 1,4-bishydroxymethylcyclohexane, 2,2-bis(4-hydroxycyclohexyl) propane, neopentylglycol, trimethylolpropane or pentaerythritol, with di-carbonates, such as dimethyl, diethyl or diphenyl carbonate, or phosgene.

Alternatively and preferred, where possible, the polycarbonate compounds Poh3 are obtained from renewable feedstock, more preferably they are polycarbonate compounds obtained from bio-based polyols (i.e. bio-based 1,3-propanediol or 1,5-pentanediol).

The monomeric compounds Moh having at least two isocyanate-reactive groups preferably are monomeric compounds having at least two hydroxyl groups, or having at least two primary amino groups, or having at least one hydroxyl group and at least one primary amino group.

Preferably the monomeric compounds Moh having at least two hydroxyl groups are selected from the group consisting of 1,2-ethanediol, 1,2-and 1,3-propanediol, 1,2-and 1,4-butanediol, 2,2′-oxydi(ethan-1-ol), 2,2-dimethyl-1,3-propanediol, 2-methyl-2,4-pentanediol, 1,4-bis-hydroxymethylcyclohexane, 1,6-hexanediol, 1,8-octanediol, 1,10-decanediol, 1,12-dodecanediol, 1,13-tridecanediol, 1, 18-octadecanediol, 1,21-heneicosanediol, 1,25-pentacosanediol, isosorbide, isomannide, isoidide, and mixtures thereof; more preferably selected from the group consisting of 1,2-ethanediol, 1,2-and 1,3-propanediol, 1,2-and 1,4-butanediol, 2,2′-oxydi (ethan-1-ol), 2,2-dimethyl-1,3-propanediol, 2-methyl-2,4-pentanediol, 1,4-bis-hydroxymethylcyclohexane, and mixtures thereof; most preferably selected from the group consisting of 1,2-ethanediol, 1,4-butanediol, 2,2′-oxydi(ethan-1-ol), 2,2-dimethyl-1,3-propanediol, and mixtures thereof.

Preferably the monomeric compounds Moh having at least two primary amino groups are selected from the group consisting of 1,4-diaminobutane, 1,6-diaminohexane, 2-methyl-1,5-diaminopentane and mixtures thereof.

Preferably the monomeric compounds Moh having at least one hydroxyl group and at least one primary amino group are selected from the group consisting of ethanolamine, propanolamine, 2-(2-amino-ethylamino-)ethanol and mixtures thereof.

The monomeric compounds Moh may comprise a mixture of one or more monomeric compounds having at least two hydroxyl groups and one or more monomeric compounds having at least two primary amino groups.

The one or more isocyanate-reactive monomers MAoh having at least two isocyanate-reactive groups and at least one acid group or an acid group precursor, such as an anhydride, preferably are monomers having at least two hydroxyl groups and at least one acid group. More preferably the one or more MAoh monomers are selected from the group consisting of 2,2-(bis-hydroxymethyl)acetic acid, 2,2-(bishydroxymethyl)-propionic acid, 2,2-(bishydroxymethyl)butyric acid and mixtures thereof.

The one or more isocyanate-reactive monomers MUoh having at least two isocyanate-reactive groups and an ethylenically unsaturated group preferably are compounds having at least two hydroxyl groups and an ethylenically unsaturated group, more preferably are selected from the group consisting of glycerol mono(meth)acrylate (also referred to as glycerine mono(meth)acrylate), trimethylolpropane mono(meth)acrylate and mixtures thereof.

The one or more primary or secondary amine(s) Aoh having at least one hydroxyl group preferably are selected from the group consisting of 2-aminoethanol, 2-methylaminoethanol, 3-aminopropanol, 2-amino-1,3-propanediol, diethanolamine, 1, 1′-iminodi-2-propanol and mixtures thereof.

Preferably the isocyanate-reactive monomers having at least two isocyanate-reactive groups and an ethylenically unsaturated group, MUoh, are provided in such an amount that the hydroxyl-functional polyurethane PUoh is characterized by an unsaturated equivalent weight (UEW) comprised between 3,500 and 35,000 g/equiv., preferably between 4,500 and 20,000 g/equiv., more preferably between 6,000 and 15,000 g/equiv.; said unsaturation being provided by the ethylenically unsaturated groups being pending groups (or the ethylenically unsaturated groups being pending groups).

Preferably the hydroxyl-functional polyurethane PUoh is characterized by an acid number between 30 and 60 mg KOH/g; said acid number being generated by the isocyanate-reactive monomers, MAoh, having at least two isocyanate-reactive groups and an at least one acid group or group being able to form an acid when contacted with water, said MAoh being incorporated for at least 95% into the polyurethane through urethane or urea linkages, preferably through urethane linkages.

Optionally hydroxyl-functional polyurethane PUoh and the acid salt groups comprising hydroxyl-functional polyurethane PUSoh comprise pendant ethylenically unsaturated groups and end-standing ethylenically unsaturated groups obtainable from monomers comprising one hydroxyl group and an ethylenically unsaturated group, such as for example hydroxyethyl (meth)acrylate, hydroxypropyl (meth)acrylate or hydroxybutyl (meth)acrylate, added as part of the MU1 monomers.

Preferably the hydroxyl-functional polyurethane PUoh and the acid salt groups comprising hydroxyl-functional polyurethane PUSoh are substantially free of end-standing ethylenically unsaturated groups. More preferably the hydroxyl-functional polyurethane PUoh and the acid salt groups comprising hydroxyl-functional polyurethane PUSoh comprise 0% end-standing ethylenically unsaturated groups.

The polyurethane-vinyl polymer hybrid prepolymer having pendant acid salt groups, PUSpp, is the reaction product of:
from 60 to 85% by weight, preferably from 65 to 80% by weight, of an acid salt groups comprising hydroxyl-functional polyurethane, PUSoh, having pendant ethylenically unsaturated groups and pendant salt groups; and
from 15 to 40% by weight, preferably from 20 to 35% by weight, of one or more polymerized ethylenically unsaturated monomer(s) MU1;
   the sum of PUSoh and MU1 being 100%.

Preferably, the polyurethane-vinyl polymer hybrid prepolymer having pendant acid salt groups, PUSpp, is characterized by a weight ratio of acid salt groups comprising hydroxyl-functional polyurethane PUSoh over vinyl polymer derived from MU1 of more than 1.

The acid salt groups comprising hydroxyl-functional polyurethane PUSoh, having pendant ethylenically unsaturated groups and pendant salt groups, comprises the reaction product of, preferably is the reaction product of:
from 30 to 50% by weight, preferably from 35 to 45% by weight, of one or more polyisocyanate(s) I;
from 30 to 40% by weight, preferably from 33 to 37% by weight, of one or more polymeric compound(s) Poh having at least two isocyanate-reactive groups;
(optionally) from 1 to 4% by weight, preferably from 2 to 3% by weight, of one or more monomeric compound(s) Moh having at least two isocyanate-reactive groups;
from 7 to 11% by weight, preferably from 8 to 10% by weight, of one or more isocyanate-reactive monomer(s) MAoh having at least two isocyanate-reactive groups and an at least one acid group;
from 0.5 to 4% by weight, preferably from 1 to 3% by weight, of one or more isocyanate-reactive monomer(s) MUoh having at least two isocyanate-reactive groups and an ethylenically unsaturated group; and
from 7 to 11% by weight, preferably from 8 to 10% by weight, of one or more primary or secondary amine(s) Aoh having at least one hydroxyl group;
   the sum of I, Poh, Moh, MAoh, MUoh and Aoh being 100%; wherein the acid group of MAoh is further converted in an acid salt through addition of one or more neutralizing compound(s) An.

The aqueous polyurethane-vinyl polymer hybrid dispersion D comprises the reaction product E of:
from 30 to 80% by weight, preferably from 40 to 70% by weight, of polymerized ethylenically unsaturated monomers MU2, in
from 20 to 70% by weight, preferably from 30 to 60% by weight, of a polyurethane-vinyl polymer hybrid prepolymer having pendant acid salt groups PUSpp; the sum of PUSpp and polymerized MU2 being 100%.

Preferably, the reaction product E of one or more ethylenically unsaturated monomer(s) MU2, the MU2 being polymerized in the presence of said polyurethane-vinyl polymer hybrid prepolymer having pendant acid salt groups PUSpp, is characterized by a weight ratio of acid salt groups comprising hydroxyl-functional polyurethane PUSoh over total vinyl polymer derived from MU1 and MU2 of 1 or less than 1. More preferably, the reaction product E of one or more ethylenically unsaturated monomer(s) MU2, the MU2 being polymerized in the presence of said polyurethane-vinyl polymer hybrid prepolymer having pendant acid salt groups, PUSpp, is characterized by a weight ratio of acid salt groups comprising hydroxyl-functional polyurethane PUSoh over total vinyl polymer derived from MU1 and MU2 of less than 1.

The aqueous polyurethane-vinyl polymer hybrid dispersion D of the invention preferably comprises:
from 40 to 55% by weight, preferably from 43 to 50% by weight, of reaction product E (or of by weight of solids), and
from 45 to 60% by weight, preferably from 50 to 57% by weight, of water.

The polyurethane-vinyl polymer hybrid (or reaction product) E of aqueous polyurethane-vinyl polymer hybrid dispersion D preferably has a core-shell structure comprising:
a core (substantially) comprising polymerized ethylenically unsaturated monomers, and
a shell (substantially) comprising polyurethane.

As apparent for the skilled person in the art, a core-shell structure can be evidenced by Transmission Electron Microscopy and Attenuated Total Reflectance-Fourier Transformed Infrared Spectroscopy.

Preferably, dispersed particles of reaction product E are characterized by a Z-average particle size according to ISO 22412 (determined by Dynamic Light Scattering), comprised between 50 and 150 nm, preferably between 60 and 120 nm.

The aqueous polyurethane-vinyl polymer hybrid dispersions D are prepared in a multi-step process comprising the steps of:
a) mixing a polymeric compound Poh having at least two isocyanate-reactive groups, preferably at least two hydroxyl groups, in the presence of one or more isocyanate-reactive monomer(s) MAoh having at least two isocyanate-reactive groups, preferably at least two hydroxyl groups, and an acid group or an acid group precursor, and optionally in the presence of one or more isocyanate-reactive monomer(s) Moh having at least two isocyanate-reactive groups, preferably at least two hydroxyl groups or at least two primary amino groups or at least an hydroxyl group and a primary amino group, and heating the mixture to a temperature of at least 60° C., preferably at least 70° C., more preferably at least 80° C., and at most 150° C., preferably at most 130° C., more preferably at most 130° C., under stirring;
b) continuously adding a sub-stoichiometric quantity of the multifunctional isocyanate I to the mixture of step a), preferably over a time period of from 10 minutes to 60 minutes, preferably of from 20 minutes to 40 minutes, while the temperature is kept in a range of from 60° C. to 150° C., preferably of from 80° C. to 130° C., thereby forming a isocyanate-reactive polyurethane prepolymer, preferably a hydroxyl-functional polyurethane prepolymer characterized by a hydroxyl number comprised between 30 and 140 mg KOH/g, preferably comprised between 40 and 130 mg KOH/g;
c) adding one or more isocyanate-reactive monomer(s) MUoh having at least two isocyanate-reactive groups, preferably at least two hydroxyl groups, and an ethylenically unsaturated group, and optionally one or more isocyanate-reactive monomer(s) Moh having at least two isocyanate-reactive groups, preferably at least two hydroxyl groups or at least two primary amino groups or at least an hydroxyl group and a primary amino group, and preferably one or more ethylenically unsaturated monomer(s) MU1, to the isocyanate-reactive polyurethane prepolymer, preferably the hydroxyl-functional prepolymer of step b), and homogenizing the mixture, optionally in the presence of an antioxidant or radical scavenger;
d) adding a further amount of multifunctional isocyanate I, while stirring at a temperature in the range of from 60° C. to 100° C., preferably in the range of from 70 to 90° C., to the homogenized mixture of step c) in stoichiometric excess thereby forming an isocyanate-functional polyurethane prepolymer, preferably said isocyanate-functional polyurethane prepolymer is characterized by an isocyanate equivalent weight comprised between 600 and 2,200 g/equiv, more preferably between 800 and 2,000 g/equiv., most preferably between 1,000 and 1,800 g/equiv., the amount of ethylenically unsaturated monomer(s) MU1 optionally added in step c) not taken into account for the determination of the equivalent weight of said isocyanate-functional polyurethane prepolymer;
e) fast addition of a mixture comprising one or more primary or secondary amine(s) Aoh having at least one hydroxyl group, and preferably one or more ethylenically unsaturated monomer(s) MU1, to the isocyanate-functional polyurethane prepolymer of step d) thereby forming an hydroxyl-functional polyurethane PUoh in ethylenically unsaturated monomer(s) MU1, preferably said hydroxyl-functional polyurethane PUoh is characterized by a hydroxyl number comprised between 10 and 100 mg KOH/g, more preferably between 15 and 85 mg KOH/g, even more preferably between 20 and 75 mg KOH/g, the amount of ethylenically unsaturated monomer(s) MU1 optionally added in step c) and/or this step e) not taken into account for the determination of the hydroxyl number of said hydroxyl-functional polyurethane PUoh;
f) adding neutralizing agent An to the mixture of step e) and homogenizing said mixture for at least 5 minutes, preferably over a time period of from 5 to 15 minutes, at a temperature in the range of from 40° C. to 80° C., preferably of from 50° C. to 80° C., thereby forming an acid salt groups comprising hydroxyl-functional polyurethane, PUSoh, in ethylenically unsaturated monomer(s) MU1;
g) adding water to the homogenized mixture of step f) thereby forming an emulsion;
h) homogenizing the emulsion of step g) at a temperature in the range of from 40° C. to 80° C., preferably in the range of from 50° C. to 70° C. for at least 10 minutes, preferably over a time period of from 20 to 30 minutes;
i) redox-polymerizing the homogenized emulsion of step h) by gradually adding at least one of the redox system components over at least 10 minutes, preferably over a time period of from 10 to 30 minutes, while maintaining the temperature in the range of from 60° C. to 80° C. thereby forming the polymerization mixture;
j) maintaining the temperature of the polymerization mixture at a temperature comprised between 65 and 85° C. for at least 15 minutes preferably over a time period of from 20 to 30 minutes, for further polymerizing thereby forming the polyurethane-vinyl polymer hybrid prepolymer having pendant acid salt groups, PUSpp;
k) fast addition of a mixture of ethylenically unsaturated monomers MU2 to the polyurethane-vinyl polymer hybrid prepolymer having pendant acid salt groups, PUSpp, of step j) and homogenizing the mixture at a temperature in the range of from 40° C. to 80° C. during at least 10 minutes, preferably over a time period of from 20 to 30 minutes;
l) redox-polymerizing the homogenized emulsion of step k) by gradually adding at least one of the redox system components over at least 10 minutes, preferably over a time period of from 10 to 30 minutes, while maintaining the temperature in the range of from 60°° C. to 80° C.° C. thereby forming the polymerization mixture;
m) maintaining the temperature in the range of from 60° C. to 80° C. for at least 15 minutes, preferably over a time period of from 20 to 30 minutes, to finalize the polymerization, thereby forming the aqueous polyurethane-vinyl polymer hybrid dispersion D1, comprising polyurethane-vinyl polymer hybrid E;

Preferably, in step c) one or more isocyanate-reactive monomer(s) MUoh having at least two isocyanate-reactive groups, preferably at least two hydroxyl groups, and an ethylenically unsaturated group, and one or more isocyanate-reactive monomers Moh having at least two isocyanate-reactive groups, preferably at least two hydroxyl groups or at least two primary amino groups or at least an hydroxyl group and a primary amino group, and preferably one or more ethylenically unsaturated monomer(s) MU1, are added to the hydroxyl-functional polyurethane prepolymer of step b), and the mixture is homogenized, optionally in the presence of an antioxidant or radical scavenger.

In the process for the preparation of the aqueous dispersion of the acid salt groups comprising hydroxyl-functional polyurethane, PUSoh, ethylenically unsaturated monomers MU1 may be added at any of the steps a) to e).

Preferably, ethylenically unsaturated monomers MU1 are added in at least one of the steps a) to e).

More preferably, ethylenically unsaturated monomers MU1 are (only) added in step c) and/or step e).

Fast adding (or fast addition) of one or more compound(s) should be understood as an addition of the one or more compound(s) over a time period which is at least 50% less, preferably at least 60% less, more preferably at least 70% less, even more preferably at least 80% less, most preferably at least 90% less, or even at least 95% less than the homogenization period of the final mixture obtained.

More particularly, fast adding of the ethylenically unsaturated monomers in step e) and k) should be understood as an addition over a time period which is at least 50% less, preferably at least 60% less, more preferably at least 70% less, even more preferably at least 80% less, most preferably at least 90% less, or even at least 95% less than the homogenization period of the final obtained mixture comprising said ethylenically unsaturated monomers. Preferably the ethylenically unsaturated monomers MU1 in step e) and MU2 in step k) are added in a one shot addition.

In the present description, “a one shot addition of one or more compound(s)” is referred to as an addition of the one or more compound(s) over a time period which is substantially 100% less than the homogenization period of the final obtained mixture.

Redox-polymerizations mentioned through the present description are polymerization methods which are well known to the skilled person in the art.

The redox-poymerization of steps i) and I) in practice comprises:
first adding the redox solution followed by the gradual addition of the peroxide; or
first adding the peroxide followed by the gradual addition of the redox solution; or
gradually feeding the redox solution and the peroxide.

The antioxidant or radical scavenger optionally added in step c) preferably is a sterically hindered phenol, such as a phenol having bulky substituents, preferably tert-butyl groups in the 2-and 6-positions and an alkyl substituent in the 4-position.

To the aqueous dispersion D1, comprising polyurethane-vinyl polymer hybrid E, a subsequent fast addition (step n)) of a mixture of ethylenically unsaturated monomers MU2 may be performed, whereupon the mixture of E and MU2 is homogenized at a temperature of 40° C. to 80° C. during at least 10 minutes, preferably over a time period of from 20 to 30 minutes (thereby forming an homogenized mixture or emulsion). The homogenized mixture is then redox-polymerized (step o)) as described in step I) (vide supra), and polymerization is finalized (step p)) as described in step m) (vide supra), resulting in the aqueous polyurethane-vinyl polymer hybrid dispersion D2 (comprising polyurethane-vinyl polymer hybrid E).

The aqueous polyurethane-vinyl polymer hybrid dispersions D of the invention are suitable for diverse uses, for example for the preparation of coating systems, as binders for water-dilutable adhesives or as resins for printing inks.

They can be combined with and are in general compatible with other aqueous dispersions and solutions of plastics, for example acrylic and/or methacrylic polymers, polyurethane, polyurea resins, polyester resins and epoxy resins, thermoplastics based on polyvinyl acetate, polyvinyl chloride, polyvinyl ether, polychloroprene, polyacrylonitrile, and ethylene/butadiene/styrene copolymers. They can also be combined with substances which have a thickening action and are based on polyacrylates or polyurethanes containing carboxyl groups, hydroxyethyl-cellulose, polyvinyl alcohols and inorganic thixotropic agents, such as bentonite, sodium-magnesium silicates and sodium-magnesium-fluorine-lithium silicates.

The aqueous polyurethane-vinyl polymer hybrid dispersions D according to the invention can be applied to the most diverse substrates, for example ceramic, wood, glass, concrete and preferably plastics, such as polycarbonate, polystyrene, polyvinyl chloride, polyester, poly(meth)acrylates, acrylonitrile/butadiene/styrene polymers and the like, and most preferably to metal, such as iron, copper, aluminum, steel, brass, bronze, tin, zinc, titanium, magnesium and the like. They adhere to the various substrates without adhesion-promoting primers or intermediate layers, although such layers may of course be present in the setup of the final coated article (and the dispersions D of the invention can even be applied to those layers as well).

The aqueous polyurethane-vinyl polymer hybrid dispersions D are suitable, for example, for the production of corrosion-preventing coatings and/or intermediate coatings for the most diverse fields of use, in particular for the production of metallic and solid base paints in multi-coat build-ups of paint for the fields of painting of automobiles and plastics, and for producing primer paints for the field of painting of plastics.

Aqueous coating systems comprising the aqueous polyurethane-vinyl hybrid polymer dispersion D can contain all the inorganic or organic pigments and dyestuffs which are known and are customary in paint technology, as well as wetting agents, foam suppressants, flow control agents, stabilisers, catalysts, fillers, plasticisers, solvents and usual additives, such as thickeners, flow modifiers, wetting agents, light stabilisers. Crosslinking agents (or crosslinkers) customary in the paint industry, such as, for example, water-soluble or-emulsifiable aminoplast crosslinkers such as urea, cyclic urea, melamine or benzoguanamine resins, polyisocyanates or prepolymers having terminal isocyanate groups, water-soluble or water-dispersible polyaziridines and blocked polyisocyanates, can be added during formulation (of the aqueous coating system). Alternatively crosslinking agents can be added during synthesis of the aqueous polyurethane-vinyl hybrid polymer dispersion D.

The aqueous coating systems comprising the aqueous polyurethane-vinyl hybrid polymer dispersion D can alternatively contain a crosslinker selected from the group of di- or polyamines, carbohydrazide, and di- or poly-carboxylic acid hydrazides and mixtures thereof. For example the crosslinker can be adipic acid dihydrazide. The crosslinker may be added to the aqueous polyurethane-vinyl hybrid polymer dispersion D during its synthesis, or can be added at a later stage, for example during the formulation of the aqueous coating system.

It is apparent for those skilled in the art to select an appropriate crosslinker depending on the desired paint application and the curing temperature used.

### EXAMPLES

The following illustrative examples are merely meant to exemplify the present invention but are not intended to limit or otherwise define its scope.

### Example 1a

### Synthesis of a Polyurethane-Vinyl Polymer Hybrid Prepolymer Having Pendant Acid Salt Groups PUSpp.

In a reactor purged with nitrogen, 369 g of a polyadipate of 1,6-hexanediol with number Average Molecular weight of 1,000 g/mole and an hydroxyl number of 112 mg KOH/g, and 79 g of dimethylolpropionic acid, were heated to 130° C. and the mixture was kept at this temperature until a homogeneous solution was formed. 117.9 g of isophorone diisocyanate were then metered in over a period of 30 minutes, while stirring was continued at 130° C. until no more free isocyanate groups could be detected.

After cooling to 100° C., 1.05 g of 2,6-di-tert-butyl-4-methylphenol, 15.5 g of 1,4-butyleneglycol, 17 g of glycerol monomethacrylate, and 254 g of 2-ethylhexylacrylate, were sequentially added and the mixture was homogenized. After further cooling to 80° C., 237.7 g of isophorone diisocyanate were added over a period of fifteen minutes, and the components were reacted at 75° C. until the theoretical NCO-content, corresponding to full conversion of isocyanate-reactive groups, was obtained and verified by titration. Then 77.8 g of diethanolamine and 106 g of methyl methacrylate were rapidly added, in one shot, and the reaction mixture was held at the resulting temperature while stirring until all isocyanate groups have reacted. After addition of 42 g of N, N-dimethylethanolamine (DMEA), the mixture was homogenized for 15 minutes at 75° C. 1350 g of de-ionized water were then added to the prepolymer solution, while stirring intensively during 30 minutes at 65° C. Subsequently, 102 g of an 1.9% aqueous solution of BRUGGOLITE® FF6M was added at 65° C. and homogenized for 10 minutes followed by the continuous addition, over 30 minutes, of 201.4 g of an 0.5 aqueous solution of tert-butyl hydroperoxide, while maintaining the temperature between 65 and 75° C. by parallel cooling. Then the reaction mixture was held for another 30 minutes at a temperature comprised between 65 and 75° C. for completing the polymerization and cooled down to room temperature (23° C.). The dispersion thus obtained had the following characteristics: solid content: 43.3%; pH (10% aqueous solution): 7.6; dynamic viscosity (100 s⁻¹, 23° C.): 324 mPa·s; Z-average particle size (ISO 22412): 39 nm.

### Example 1b

### Synthesis of an Aqueous Polyurethane Vinyl-Polymer Dispersion D1.

To the reactor purged with nitrogen, comprising the polyurethane-vinyl polymer hybrid prepolymer having pendant acid salt groups, PUSpp, of Example 1a, 250 g of de-ionized water were added. The resulting dispersion was heated to 60° C. whereupon 225 g of methyl methacrylate and 450 g of 2-ethylhexyl acrylate were rapidly added, in one shot. The resulting mixture was homogenized for 30 minutes at 60° C. Subsequently, 208 g of a 3.8% aqueous solution of BRUGGOLITE® FF6M was added and homogenized for 10 minutes at 60° C., followed by the continuous addition, over 30 minutes, of 253 g of a 0.8 aqueous solution of tert-butyl hydroperoxide. The reaction temperature was allowed to rise to 75° C. while maintaining the temperature below 80° C. by parallel cooling. Once the addition of the tert-butyl hydroperoxide solution was finished, the reaction media was cooled down to 65° C. and maintained at this temperature for 30 minutes.

### Example 1c

### Synthesis of an Aqueous Polyurethane Vinyl-Polymer Dispersion D2.

To the aqueous polyurethane vinyl-polymer dispersion D1 of Example 1b, standing at 65° C., 225 g of methyl methacrylate and 450 g of 2-ethylhexyl acrylate were rapidly added, in one shot, and the reaction mixture was homogenized for 30 minutes at 65° C. Subsequently 253 g of a 0.8 aqueous solution of tert-butyl hydroperoxide was continuously added over 30 minutes allowing the temperature of the reaction mixture to rise to 75° C. while maintaining the temperature below 80° C. by parallel cooling. Once the addition of the tert-butyl hydroperoxide solution was finished the reaction media was cooled down to 65° C. and maintained at this temperature for 30 minutes. The dispersion thus obtained had the following characteristics: solid content: 49.7%; pH (10% aqueous solution): 7.7; dynamic viscosity (100 s⁻¹, 23° C.): 737 mPa·s; Z-average particle size (ISO 22412): 102 nm.

### Examples 2 to 14 and Comparative Examples 1 to 3

In Table 1A the different components for the preparation of the polyurethane-vinyl polymer hybrid prepolymer having pendant acid salt groups, PUSpp, of Example 2a to Example 8a along with the characteristics of said PUSpp are presented.

In Table 1B the different components for the preparation of polyurethane-vinyl polymer hybrid prepolymer having pendant acid salt groups, PUSpp, of Comparative Example 1a to Comparative Example 3a along with the characteristics of said PUSpp are presented.

In Tables 2A and 2B the different components for the preparation of the aqueous polyurethane vinyl-polymer dispersion D1 of Example 2b to Example 14b, prepared from the polyurethane-vinyl polymer hybrid prepolymer having pendant acid salt groups, PUSpp, of Example 1a to Example 8a, are presented, wherein in Table 2A:
Example 2b to Example 5b are prepared from PUSpp of Example 1a;
Example 6b and Example 7b are prepared from PUSpp of Example 2a;
Example 8b is prepared from PUSpp of Example 3a;
Example 9b and Example 10b are prepared from PUSpp of Example 4a; and
   wherein in Table 2B:
Example 11b is prepared from PUSpp of Example 5a;
Example 12b is prepared from PUSpp of Example 6a;
Example 13b is prepared from PUSpp of Example 7a;
Example 14b is prepared from PUSpp of Example 8a.

In Table 2C the different components for the preparation of the aqueous polyurethane vinyl-polymer dispersion D1 of Comparative Example 1b to Comparative Example 3b, prepared from the acid salt groups comprising polyurethane-vinyl polymer hybrid prepolymers, PUSpp, of Comparative Example 1a to Comparative Example 3a, are presented, wherein
Comparative Example 1b is prepared from PUSpp of Comparative Example 1a;
Comparative Example 2b is prepared from PUSpp of Comparative Example 2a; and
Comparative Example 3b is prepared from PUSpp of Comparative Example 3a.

In Tables 3A and 3B the different components for the preparation of the aqueous polyurethane vinyl-polymer dispersion D2 of Example 2c to Example 14c, prepared from the aqueous polyurethane vinyl-polymer dispersion D1 of Example 2b to Example 14b, along with the characteristics of said aqueous polyurethane vinyl-polymer dispersion D2 are presented. The components listed in Table 3A were added to the dispersions D1 prepared in Example 2b to Example 10b of Table 2A without isolation. The components listed in Table 3B were added to the dispersions D1 prepared in Example 11b to 14b of Table 2B without isolation.

In Table 3C the different components for the preparation of the aqueous polyurethane vinyl-polymer dispersion D2 of Comparative Example 1c to Comparative Example 3c, prepared from the aqueous polyurethane vinyl-polymer dispersion D1 of Comparative Example 1b to Comparative Example 3b, along with the characteristics of said aqueous polyurethane vinyl-polymer dispersion D2 are presented. The components listed in Table 3C were added to the dispersions D1 prepared in Comparative Example 1b to Comparative Example 3b of Table 2C without isolation.

TABLE 1A

| Components | Ex. 2a | Ex. 3a | Ex. 4a | Ex. 5a | Ex. 6a | Ex. 7a | Ex. 8a |
|---|---|---|---|---|---|---|---|
| Polyester diol 1 | 369.00 g | — | 369.00 g | — | — | 123.00 g | 369.00 g |
| | (0.3690 | | (0.3690 | | | (0.1230 | (0.3690 |
| | mole) | | mole) | | | mole) | mole) |
| Polyester diol 2 | — | 369.00 g | — | — | — | — | — |
| | | (0.3690 | | | | | |
| | | mole) | | | | | |
| Polycarbonate diol 1000 | — | — | — | 369.00 g | — | 123.00 g | — |
| | | | | (0.3690 | | (0.1230 | |
| | | | | mole) | | mole) | |
| Poly-THF 1000 | — | — | — | — | 369.00 g | 123.00 g | — |
| | | | | | (0.3690 | (0.1230 | |
| | | | | | mole) | mole) | |
| Dimethylol propionic acid | 79.00 g | 79.00 g | 79.00 g | 79.00 g | 79.00 g | 79.00 g | 79.00 g |
| | (0.5890 | (0.5890 | (0.5890 | (0.5890 | (0.5890 | (0.5890 | (0.5890 |
| | mole) | mole) | mole) | mole) | mole) | mole) | mole) |
| Isophorone diisocyanate | 117.90 g | 117.90 g | 117.90 g | 117.90 g | 117.90 g | 117.90 g | 117.90 g |
| | (0.5304 | (0.5304 | (0.5304 | (0.5304 | (0.5304 | (0.5304 | (0.5304 |
| | mole | mole) | mole) | mole) | mole) | mole) | mole) |
| 2,6-Di-tert-butyl-p-cresol (BHT) | 1.05 g | 1.05 g | 1.05 g | 1.05 g | 1.05 g | 1.05 g | 1.05 g |
| | (0.0048 | (0.0048 | (0.0048 | (0.0048 | (0.0048 | (0.0048 | (0.0048 |
| | mole | mole | mole) | mole) | mole) | mole) | mole) |
| 1,4-Butane diol | 15.53 g | 15.53 g | 15.53 g | 15.53 g | 15.53 g | 15.53 g | — |
| | (0.1724 | (0.1724 | (0.1724 | (0.1724 | (0.1724 | (0.1724 | |
| | mole) | mole) | mole) | mole) | mole) | mole) | |
| Glycerol monomethacrylate | 17.00 g | 17.00 g | 17.00 g | 17.00 g | 17.00 g | 17.00 g | 17.00 g |
| | (0.1061 | (0.1061 | (0.1061 | (0.1061 | (0.1061 | (0.1061 | (0.1061 |
| | mole) | mole) | mole) | mole) | mole) | mole) | mole) |
| Hydroxyethyl methacrylate | — | — | — | — | — | — | — |
| Methyl methacrylate | 254.00 g | — | — | — | — | — | — |
| | (2.5367 | | | | | | |
| | mole) | | | | | | |
| 2-Ethylhexyl acrylate | — | 254.00 g | 254.00 g | 254.00 g | 254.00 g | 254.00 g | 236.01 g |
| | | (1.3783 | (1.3783 | (1.3783 | (1.3783 | (1.3783 | (1.2807 |
| | | mole) | mole) | mole) | mole) | mole) | mole) |
| Isophorone diisocyanate | 237.67 g | 237.67 g | 237.67 g | 237.67 g | 237.67 g | 237.67 g | 199.35 g |
| | (1.0692 | (1.0692 | (1.0692 | (1.0692 | (1.0692 | (1.0692 | (0.8968 |
| | mole) | mole) | mole) | mole) | mole) | mole) | mole) |
| Diethanol amine | 77.81 g | 77.81 g | 77.81 g | 77.81 g | 77.81 g | 77.81 g | 77.81 g |
| | (0.7401 | (0.7401 | (0.7401 | (0.7401 | (0.7401 | (0.7401 | (0.7401 |
| | mole) | mole) | mole) | mole) | mole) | mole) | mole) |
| Methyl methacrylate | 106.00 g | 106.00 g | 41.00 g | 106.00 g | 106.00 g | 106.00 g | 98.46 g |
| | (1.0586 | (1.0586 | (0.4095 | (1.0586 | (1.0586 | (1.0586 | (0.9833 |
| | mole) | mole) | mole) | mole) | mole) | mole) | mole) |
| 2-Ethylhexyl acrylate | — | — | — | — | — | — | — |
| Diacetone acrylamide | — | — | 65.00 g | — | — | — | — |
| | | | (0.3841 | | | | |
| | | | mole) | | | | |
| Dimethyl ethanolamine | 42.00 g | 42.00 g | 42.00 g | 42.00 g | 42.00 g | 42.00 g | 42.00 g |
| | (0.4712 | (0.4712 | (0.4712 | (0.4712 | (0.4712 | (0.4712 | (0.4712 |
| | mole) | mole) | mole) | mole) | mole) | mole) | mole) |
| De-ionized water | 1350.00 g | 1350.00 g | 1350.00 g | 1350.00 g | 1350.00 g | 1350.00 g | 1240.00 g |
| | (74.9168 | (74.9168 | (74.9168 | (74.9168 | (74.9168 | (74.9168 | (68.8125 |
| | mole) | mole) | mole) | mole) | mole) | mole) | mole) |
| 1.9% aqueous solution of | 101.96 g | 101.96 g | 101.96 g | 101.96 g | 101.96 g | 101.96 g | 101.96 g |
| BRUGGOLITE ® FF6M | | | | | | | |
| 0.5% aqueous solution of | 201.43 g | 201.43 g | 201.43 g | 201.43 g | 201.43 g | 201.43 g | 201.43 g |
| t-butyl hydroperoxide | | | | | | | |

Testing parameters

| | | | | | | | |
|---|---|---|---|---|---|---|---|
| Solids content [%] | 43.0% | 42.8% | 43.6% | 42.6% | 43.3% | 43.2% | 43.2% |
| pH (10% aqueous solution) | 8.4 | 8.4 | 7.7 | 7.7 | 8.1 | 7.8 | 7.6 |
| Particle size average (nm) | 41 | 49 | 53 | 47 | 37 | 38 | 43 |
| Dynamic viscosity (mPa · s) | 261 | 1336 | 3137 | 367 | 475 | 341 | 182 |
| (100 1/s; 23° C.) | | | | | | | |

TABLE 1B

| Components | Comp. Ex. 1a | Comp. Ex. 2a | Comp. Ex. 3a |
|---|---|---|---|
| Polyester diol 1 | 369.00 g | 369.00 g | 369.00 g |
| | (0.3690 mole) | (0.3690 mole) | (0.3690 mole) |
| Polyester diol 2 | — | — | — |
| Polycarbonate diol 1000 | — | — | — |
| Poly-THF 1000 | — | — | — |
| Dimethylol propionic acid | 79.00 g (0.5890 mole) | 79.00 g | 79.00 g |
| | | (0.5890 mole) | (0.5890 mole) |
| Isophorone diisocyanate | 117.90 g | 117.90 g | 117.90 g |
| | (0.5304 mole) | (0.5304 mole) | (0.5304 mole) |
| 2.6-Di-tert-butyl-p-cresol (BHT) | 1.05 g | 1.05 g | 1.05 g |
| | (0.0048 mole) | (0.0048 mole) | (0.0048 mole) |
| 1.4-Butane diol | 25.09 g | — | 25.09 g |
| | (0.2785 mole) | | (0.2785 mole) |
| Glycerol monomethacrylate | — | 44.62 g | — |
| | | (0.2785 mole) | |
| Hydroxyethyl methacrylate | — | — | 13.02 g |
| | | | (0.1000 mole) |
| Methyl methacrylate | — | — | — |
| 2-Ethylhexyl acrylate | 254.00 g | 254.00 g | 254.00 g |
| | (1.3783 mole) | (1.3783 mole) | (1.3783 mole) |
| Isophorone diisocyanate | 237.67 g | 237.67 g | 237.67 g |
| | (1.0692 mole) | (1.0692 mole) | (1.0692 mole) |
| Diethanol amine | 77.81 g | 77.81 g | 67.30 g |
| | (0.7401 mole) | (0.7401 mole) | (0.6401 mole) |
| Methyl methacrylate | 106.00 g | 106.00 g | 106.00 g |
| | (1.0586 mole) | (1.0586 mole) | (1.0586 mole) |
| 2-Ethylhexyl acrylate | — | — | — |
| Diacetone acrylamide | — | — | — |
| Dimethyl ethanolamine | 42.00 g | 42.00 g | 42.00 g |
| | (0.4712 mole) | (0.4712 mole) | (0.4712 mole) |
| De-ionized water | 1350.00 g | 1350.00 g | 1350.00 g |
| | (74.9168 mole) | (74.9168 mole) | (74.9168 mole) |
| 1.9% aqueous solution of | 101.96 g | 101.96 g | 101.96 g |
| BRUGGOLITE ® FF6M | | | |
| 0.5% aqueous solution of | 201.43 g | 201.43 g | 201.43 g |
| t-butyl hydroperoxide | | | |

Testing parameters

| | | | |
|---|---|---|---|
| Solids content [%] | 43.0% | 43.2% | 43.1% |
| pH (10% aqueous solution) | 7.5 | 7.7 | 8.0 |
| Particle size average (nm) | 39 | 71 | 51 |
| Dynamic viscosity (mPa.s) | 150 | 27800 | 730 |
| (100 1/s; 23° C.) | | | |

TABLE 2A

| Components | Ex. 2b | | Ex. 3b | | Ex. 4b | | Ex. 5b | | Ex. 6b | | Ex. 7b | | Ex. 8b | | Ex. 9b | | Ex. 10b | |
|---|---|---|---|---|---|---|---|---|---|---|---|---|---|---|---|---|---|---|
| Ex. 1a | 2970.35 | g | 2970.35 | g | 2970.35 | g | 2970.35 | g | — | | — | | — | | — | | — | |
| Ex. 2a | — | | — | | — | | — | | 2970.35 | g | 2970.35 | g | — | | — | | — | |
| Ex. 3a | — | | — | | — | | — | | — | | — | | 2970.35 | g | — | | — | |
| Ex. 4a | — | | — | | — | | — | | — | | — | | — | | 2970.35 | g | 2970.35 | g |
| de-ionized water | 750.00 g | | 750.00 g | | 550.00 g | | 125.00 g | | 750.00 g | | 750.00 g | | 750.00 g | | 750.00 g | | 250.00 g | |
| | (41.6313 | | (41.6313 | | (30.5296 | | (6.9386 | | (41.6313 | | (41.6313 | | (41.6313 | | (41.6313 | | (13.8771 | |
| | mole) | | mole) | | mole) | | mole) | | mole) | | mole) | | mole) | | mole | | mole) | |
| Methyl methacrylate | 490.00 g | | 320.00 g | | 145.00 g | | 409.00 g | | 490.00 g | | 490.00 g | | 490.00 g | | 490.00 g | | 225.00 g | |
| | (4.8936 | | (3.1958 | | (1.4481 | | (4.0847 | | (4.8936 | | (4.8936 | | (4.8936 | | (4.8936 | | (2.2471 | |
| | mole) | | mole) | | mole) | | mole) | | mole | | mole) | | mole) | | mole) | | mole) | |
| 2-Ethylhexyl | 150.00 g | | — | | 340.00 g | | 46.00 g | | 185.00 g | | 150.00 g | | 150.00 g | | 150.00 g | | 450.00 g | |
| acrylate | (0.8140 | | | | (1.8450 | | (0.2496 | | (1.0039 | | (0.8140 | | (0.8140 | | (0.8140 | | (2.4419 | |
| | mole) | | | | mole) | | mole) | | mole) | | mole) | | mole) | | mole) | | mole) | |
| 1,6-Hexanediol | 35.00 g | | 35.00 g | | 85.00 g | | — | | — | | 35.00 g | | 35.00 g | | 35.00 g | | — | |
| diacrylate | (0.1549 | | (0.1549 | | (0.3761 | | | | | | (0.1549 | | (0.1549 | | (0.1549 | | | |
| | mole) | | mole) | | mole) | | | | | | mole) | | mole) | | mole) | | | |
| Styrene | — | | 320.00 g | | — | | — | | — | | — | | — | | — | | — | |
| | | | (3.0725 | | | | | | | | | | | | | | | |
| | | | mole) | | | | | | | | | | | | | | | |
| Hydroxyethyl | — | | — | | 105.00 g | | 125.00 g | | — | | — | | — | | — | | — | |
| methacrylate | | | | | (0.8068 | | (0.9604 | | | | | | | | | | | |
| | | | | | mole) | | mole) | | | | | | | | | | | |
| 3.8% aq. Sol. of | 207.88 | g | 207.88 | g | 207.88 | g | 103.94 | g | 207.88 | g | 207.88 | g | 207.88 | g | 207.88 | g | 207.88 | g |
| BRUGGOLITE ® | | | | | | | | | | | | | | | | | | |
| FF6M | | | | | | | | | | | | | | | | | | |
| 0.8% aq. Sol. | 252.87 | g | 252.87 | g | 252.87 | g | 252.87 | g | 252.87 | g | 252.87 | g | 252.87 | g | 252.87 | g | 252.87 | g |
| of t-butyl | | | | | | | | | | | | | | | | | | |

hydroperoxide

TABLE 2B

| Components | Ex. 11b | Ex. 12b | Ex. 13b | Ex. 14b |
|---|---|---|---|---|
| Ex. 5a | 2970.35 g | — | — | — |
| Ex. 6a | — | 2970.35 g | — | — |
| Ex. 7a | — | — | 2970.35 g | — |
| Ex. 8a | — | — | — | 2780.97 g |
| de-ionized water | 250.00 g | 250.00 g | 250.00 g | 250.00 g |
| | (13.8771 | (13.8771 | (13.8771 | (13.8771 |
| | mole) | mole) | mole) | mole) |
| Methyl methacrylate | 225.00 g | 225.00 g | 225.00 g | 211.42 g |
| | (2.2471 | (2.2471 | (2.2471 | (2.1114 |
| | mole) | mole) | mole) | mole) |
| 2-Ethylhexyl acrylate | 450.00 g | 450.00 g | 450.00 g | 422.84 g |
| | (2.4419 | (2.4419 | (2.4419 | (2.2945 |
| | mole) | mole) | mole) | mole) |
| 3.8% aqueous | 207.88 g | 207.88 g | 207.88 g | 207.88 g |
| solution of | | | | |
| BRUGGOLITE ® | | | | |
| FF6M | | | | |
| 0.8% aqueous | 252.87 g | 252.87 g | 252.87 g | 252.87 g |
| solution of | | | | |
| t-butyl hydroperoxide | | | | |

TABLE 2C

| Components | Comp. Ex. 1b | Comp. Ex. 2b | Comp. Ex. 3b |
|---|---|---|---|
| Comp. Ex. 1a | 2962.91 g | — | — |
| Comp. Ex. 2a | — | 2982.44 g | — |
| Comp. Ex. 3a | — | — | 2965.42 g |
| de-ionized water | 250.00 g | 250.00 g | 750.00 g |
| | (13.8771 mole) | (13.8771 mole) | (41.6313 mole) |
| Methyl methacrylate | 225.00 g | 225.00 g | 225.00 g |
| | (2.2471 mole) | (2.2471 mole) | (2.2471 mole) |
| 2-Ethylhexyl acrylate | 450.00 g | 450.00 g | 450.00 g |
| | (2.4419 mole) | (2.4419 mole) | (2.4419 mole) |
| 3.8% aqueous solution of | 207.88 g | — | 207.88 g |
| BRUGGOLITE ® FF6M | | | |
| 0.8% aqueous solution of | 252.87 g | — | 252.87 g |
| t-butyl hydroperoxide | | | |

TABLE 3A

| Components | Ex. 2c | Ex. 3c | Ex. 4c | Ex. 5c | Ex. 6c | Ex. 7c | Ex. 8c | Ex. 9c | Ex. 10c |
|---|---|---|---|---|---|---|---|---|---|
| Methyl methacrylate | 490.00 g | 490.00 g | 145.00 g | — | 490.00 g | 490.00 g | 490.00 g | 490.00 g | 225.00 g |
| | (4.8936 | (4.8936 | (1.4481 | | (4.8936 | (4.8936 | (4.8936 | (4.8936 | (2.2471 |
| | mole) | mole) | mole) | | mole) | mole | mole | mole) | mole) |
| 2-Ethylhexyl acrylate | 150.00 g | 150.00 g | 340.00 g | — | 185.00 g | 150.00 g | 150.00 g | 150.00 g | 450.00 g |
| | (0.8140 | (0.8140 | (1.8450 | | (1.0039 | (0.8140 | (0.8140 | (0.8140 | (2.4419 |
| | mole) | mole) | mole) | | mole) | mole) | mole | mole) | mole) |
| 1,6-Hexanediol diacrylate | 35.00 g | 35.00 g | 85.00 g | — | — | 35.00 g | 35.00 g | 35.00 g | — |
| | (0.1549 | (0.1549 | (0.3761 | | | (0.1549 | (0.1549 | (0.1549 | |
| | mole) | mole) | mole) | | | mole) | mole) | mole) | |
| Hydroxyethyl methacrylate | — | — | 105.00 g | — | — | — | — | — | — |
| | | | (0.8068 | | | | | | |
| | | | mole) | | | | | | |
| 0.8% aqueous solution of | 252.87 g | 252.87 g | 252.87 g | — | 252.87 g | 252.87 g | 252.87 g | 252.87 g | 252.87 g |
| t-butyl hydroperoxide | | | | | | | | | |
| Adipic acid dihydrazide | — | — | — | — | — | — | — | 33.45 g | 33.45 g |
| | | | | | | | | (0.1920 | (0.1920 |
| | | | | | | | | mole) | mole) |

Testing parameters

| | | | | | | | | | |
|---|---|---|---|---|---|---|---|---|---|
| Solids content [%] | 45.6% | 45.6% | 47.1% | 46.2% | 45.4% | 44.8% | 46.0% | 46.3% | 49.8% |
| pH (10% aqueous solution) | 7.7 | 7.8 | 8.1 | 7.8 | 8.1 | 7.9 | 8.0 | 8.0 | 7.9 |
| Particle size average (nm) | 110 | 105 | 102 | 66 | 83 | 115 | 91 | 102 | 105 |
| Dynamic viscosity (mPa · s) | 251 | 296 | 950 | 43 | 182 | 810 | 132 | 427 | 1034 |
| (100 1/s; 23° C.) | | | | | | | | | |

TABLE 3B

| Components | Ex. 11c | Ex. 12c | Ex. 13c | Ex. 14c |
|---|---|---|---|---|
| Methyl methacrylate | 225.00 g | 225.00 g | 225.00 g | 211.42 g |
| | (2.2471 | (2.2471 | (2.2471 | (2.1114 |
| | mole) | mole) | mole) | mole) |
| 2-Ethylhexyl acrylate | 450.00 g | 450.00 g | 450.00 g | 422.84 g |
| | (2.4419 | (2.4419 | (2.4419 | (2.2945 |
| | mole) | mole) | mole) | mole) |
| 0.8% aqueous | 252.87 g | 252.87 g | 252.87 g | 252.87 g |
| solution of | | | | |
| t-butyl hydroperoxide | | | | |
| Testing parameters | | | | |
| Solids content [%] | 50.0% | 50.4% | 49.7% | 50.0% |
| pH (10% aqueous | 7.6 | 8.2 | 8.0 | 7.7 |
| solution) | | | | |
| Particle size average | 127 | 77 | 84 | 66 |
| (nm) | | | | |
| Dynamic viscosity | 1240 | 975 | 860 | 728 |
| (mPa.s) | | | | |
| (100 1/s; 23° C.) | | | | |

TABLE 2C

| | Comp. | Comp. | Comp. |
|---|---|---|---|
| Components | Ex. 1c | Ex. 2c | Ex. 3c |
| Methyl | 225.00 g | — | 225.00 g |
| methacrylate | (2.2471 mole) | | (2.2471 mole) |
| 2-Ethylhexyl | 450.00 g | — | 450.00 g |
| acrylate | (2.4419 mole) | | (2.4419 mole) |
| 0.8% aqueous | 252.87 g | | 252.87 g |
| solution of t-butyl | | | |
| hydroperoxide | | | |

Testing parameters

| | | | |
|---|---|---|---|
| Solids content | 48.5% | Reaction media | 45.3% |
| [%] | | gels upon | |
| pH (10% aqueous | 7.7 | addition of | 8.0 |
| solution) | | (meth)acrylate | |
| | | components; | |
| Particle size | 56 | unable to | 90 |
| average (nm) | | homogenize due | |
| | | to drastic | |
| | | viscosity | |
| Dynamic | 544 | increase; | 138 |
| viscosity (mPa.s) | | | |
| (100 1/s; 23° C.) | | reaction aborted | |

In Tables 1A and 1B, the Examples 2a to 8a and Comparative examples 1a to 3a illustrate the composition for the preparation of a polyurethane-vinyl polymer hybrid prepolymer having pendant acid salt groups, PUSpp wherein:
polyester diol 1 (Poh): is a polyester prepared from adipic acid and a stoichiometric excess of 1,6-hexanediol characterized by a Number Average Molecular weight of 1,000 g/mole;
polyester diol 2 (Poh): is a polyester prepared from adipic acid and a stoichiometric excess of 2,2′-dimethyl-1,3-propanediol characterized by a Number Average Molecular weight of 1,000 g/mole;
poly THF 1000 (Poh): is poly(tetramethylene oxide) characterized by a Number Average Molecular weight of 1,000 g/mole;
polycarbonate diol 1000 (Poh): is the reaction product of dimethyl carbonate and a stoichiometric excess of 1,6-hexanediol characterized by a Number Average Molecular weight of 1,000 g/mole;

In Comparative Example 1a, the hydroxyl-functional polyurethane PUoh does not comprise ethylenically unsaturated bonds.

In Comparative Example 2a, the amount of pendant ethylenically unsaturated double bonds in the hydroxyl-functional polyurethane PUoh is too high (3,322 g/equiv.)).

In Comparative Example 3a, the hydroxyl-functional polyurethane PUoh only comprises end-standing ethylenically unsaturated double bonds.

### Comparative Example 4

In a reactor purged with nitrogen, 369 g of a polyadipate of 1,6-hexanediol with number Average Molecular weight of 1,000 g/mole and an hydroxyl number of 112 mg KOH/g, and 79 g of dimethylolpropionic acid were heated to 130° C. and the mixture was kept at this temperature until a homogeneous solution was formed. 117.9 g of isophorone diisocyanate were then metered in over a period of 30 minutes, while stirring was continued at 130° C. until no more free isocyanate groups could be detected.

After cooling to 100° C., 1.05 g of 2,6-di-tert-butyl-4-methylphenol, 15.5 g of 1,4-butyleneglycol, 17 g of glycerol monomethacrylate, and 254 g of 2-ethylhexylacrylate, were sequentially added and the mixture was homogenised. After further cooling to 80° C., 237.7 g of isophorone diisocyanate were added over a period of fifteen minutes, and the components were reacted at 75° C. until the theoretical NCO-content, corresponding to full conversion of isocyanate-reactive groups, was obtained and verified by titration. Then 77.8 g of diethanolamine and 106 g of methyl methacrylate were continuously added, and the reaction mixture was held at the resulting temperature while stirring until all isocyanate groups have reacted. After addition of 42 g of N, N-dimethylethanolamine, the mixture was homogenized for 15 minutes at 75° C. 1350 g of de-ionized water were then added to the prepolymer solution, while stirring intensively during 30 minutes at 65° C. Subsequently, 102 g of an 1.9% aqueous solution of BRUGGOLITER FF6M was added at 65° C. and homogenized for 10 minutes followed by the continuous addition, over 30 minutes, of 201.4 g of an 0.5 aqueous solution of tert-butyl hydroperoxide, while maintaining the temperature between 65 and 75° C. by parallel cooling. Then the reaction mixture was held for another 30 minutes at a temperature comprised between 65 and 75° C. for completing the polymerization (thereby obtaining PUSpp).

Subsequently 250 g of de-ionized water were added. The resulting dispersion was heated to 60° C. whereupon 208 g of a 3.8% aqueous solution of BRUGGOLITE® FF6M was added and homogenized for 10 minutes at 60° C. Subsequently a premixed monomer blend comprising 450 g of methyl methacrylate and 900 g of 2-ethylhexyl acrylate and 505.74 g of a 0.8 aqueous solution of tert-butyl hydroperoxide were continuously added, in parallel, over a time period of 3 hours under stirring while maintaining the temperature 60 and 65° C. by external cooling. During the 3^{rd} hour of the parallel feed of monomers and hydroperoxide solution, a drastic viscosity increase and very significant coagulum formation was observed. Finally, the reaction needed to be aborted after 2.5 hours of the parallel feed of monomers and hydroperoxide solution due to complete coagulation of the reaction product.

### Comparative Example 5

Comparative Example 4 was repeated wherein 250 g of deionized water and 10.21 g of DOWFAX™ 2A1 (external surfactant) was added to the PUSpp of Comparative Example 4. The resulting dispersion was heated to 60° C. whereupon 208 g of a 3.8% aqueous solution of BRUGGOLITE® FF6M was added and homogenized for 10 minutes at 60° C. Subsequently a premixed monomer blend comprising 450 g of methyl methacrylate and 900 g of 2-ethylhexyl acrylate and 505.74 g of a 0.8 aqueous solution of tert-butyl hydroperoxide were continuously added, in parallel, over a time period of 3 hours under stirring while maintaining the temperature 60 and 65° C. by external cooling. Once both additions were finished the reaction media was cooled down to 65° C. and maintained at this temperature for 30 minutes. The dispersion thus obtained had the following characteristics solid content: 49.8%; pH (10% aqueous solution): 7.5; dynamic viscosity (100 s⁻¹, 23° C.): 851 mPa·s; Z-average particle size (ISO 22412): 72 nm.

The synthesis of the aqueous dispersion of Comparative Example 5 was carried out without any problem, rise in viscosity and/or coagulum formation was not observed throughout the reaction, yet application results were bad due to the presence of external surfactant.

Application test were conducted using steel sheets coated with a usual multi-layer coating as used in car bodies by the automotive industry. The following paints were therefor prepared:

### Example 15

### CED Resin

2572 g of an epoxy resin based on bisphenol A, having a number average molecular weight of 380 g/mole, 440 g of a polycaprolactone diol having a number average molecular weight of 550 g/mole, 661 g of bisphenol A, and 1734 g of methoxypropanol were sequentially filled into a resin kettle, and heated under stirring to 43° C. The mixture was stirred for further thirty minutes, and then cooled to 41° C. At this temperature, 221 g of diethanolamine and then, 194 g of dimethylaminopropylamine, were added, whereupon the temperature rose to a maximum of 125° C. under cooling. After continuing the reaction for two more hours under stirring at 125° C., the dynamic viscosity of a sample drawn and diluted to a mass fraction of 40% with methoxypropanol, measured at 23° C. and a shear rate of 25 s⁻¹, was 765 mPa·s. The reaction mass was then cooled to 120° C.

### Example 16

### CED Curing Agent

In a separate step, 105 g of diethanolamine and 102 g of propylene carbonate were reacted at 120° C. for three hours to form an adduct. 687.5 g of MDI were charged under exclusion of humidity into a resin kettle. At 25° C., 445.5 g of diethylene glycol monobutylether were slowly added under gentle cooling, keeping the temperature at a maximum of 40° C. The mass fraction of isocyanate groups, calculated as —N═C═O, molar mass 42.02 g/mole, was 9.9%. At a temperature of 40° C., 207 g of the adduct made in the first step were added together with 0.4 g of dibutyltin dilaurate. Due to the exothermic reaction, the temperature rose to 80° C. which was kept as upper limit by cooling. Reaction was continued under stirring for three hours at that temperature. 5 g of ethanol and 61.8 g of methoxypropanol were then added at 80° C., and stirring was continued for one further hour. 60 g of water were then added, and the mixture was homogenised while lowering the temperature to ambient (23° C.).

### Example 17

### CED Resin Emulsion

5822 g of the resin solution of Example 15 were charged to a reaction vessel, and heated to 120° C. under stirring. 1426 g of methoxypropanol were distilled off at that temperature under reduced pressure. Then, the remaining liquid was cooled to 95° C., and 107 g of deionised water were added, thus lowering the temperature to 80° C. 2408 g of the curing agent of Example 16 were then added, and the mixture was homogenised at 80° C. for one hour.

In a separate step, an acidic catalyst solution was prepared by dissolving 107 g of bismuth trioxide in 298.3 g of an aqueous solution of methanesulfonic acid with a mass fraction of solute of 70%, and diluting after complete dissolution by adding 7913 g of deionised water. The homogenised mixture of resin and curing agent was then added to this catalyst solution within thirty minutes under thorough stirring, whereby the mixture assumed a temperature of 40° C. The mixture was stirred for two more hours at this temperature, and then diluted by addition of 2058 g of deionised water to a mass fraction of solids of 37%.

### Example 18

### Grinding Resin

258 g of 2-ethylhexylamine were charged into a resin kettle equipped with a stirrer, a thermometer and distillation facilities and heated to 80° C. At this temperature, 380 g of an epoxy resin made from polypropylene glycol and epichlorohydrin, having a specific content of epoxide groups of 5.26 mole/kg, were added evenly over one hour with the temperature rising to 120° C. The reaction was continued at 120° C. for one further hour. Next, 1175 g of 2-butoxyethanol were added, and the temperature was lowered to 70° C. whereupon 1900 g of an epoxy resin based on bisphenol A and epichlorohydrin having a specific content of epoxide groups of 2.11 mole/kg were added. The mixture was heated to 120° C. and left to react for ninety minutes. The intermediate thus obtained has a mass fraction of polyoxyalkylene units (—CH(CH3)—CH2—O—) of 11%, and a mass fraction of alkyl groups having more than three carbon atoms of 9%.

This intermediate was brought to a temperature of 100° C., and 204 g of 3-(N, N-dimethyl)-aminopropylamine-1 were added, and the mixture was reacted at 100° C. for one hour. 314 g of 2-butoxyethanol were then added, together with 66 g of paraformaldehyde having a mass fraction of formaldehyde of 91%. The temperature was raised to 140° C. and 36 g of water formed in the reaction were distilled off azeotropically using methyl isobutylketone as carrier. When the water was separated, the ketone was removed by distillation under reduced pressure, and the remainder was diluted to a mass fraction of solids of 55% by adding 774 g of 2-butoxyethanol.

### Example 19

### Pigment Paste

The following materials were added to a mixing vessel in the order shown: 207.9 g of deionised water, 16.9 g of aqueous acetic acid (30 g of acetic acid in 100 g of the aqueously diluted solution), 18.7 g of 2-butoxyethanol, 268 g of the grinding resin solution of Example 18, 10.2 g of a 50% strength solution of 2,4,7,9-tetramethyl-5-decyne-4,6-diol in 2-butoxyethanol (SURFYNOL® 104 BC, Air Products Nederland B. V.), 7.3 g of a carbon black pigment (PRINTEX® 201, Evonik Industries), and 479.2 g of a titanium dioxide white pigment (KRONOS® RN 59, Kronos Titan GmbH). The mixture was dispersed in a dissolver for fifteen minutes, and then ground in a ball mill for one hour.

### Example 20

### Preparation of CED Coating Composition

CED coating compositions were prepared from the emulsion of Example 17, the pigment paste of Example 19 and water, according to the following recipe:
3392 g CED Resin Emulsion (Example 17);
5982 g deionised water, and
626 g pigment paste (Example 19).
   The ingredients were blended in the order shown under stirring and homogenised for thirty minutes at 23° C.

### Example 21

### Preparation of Primer/Surfacer Coating Composition

The primer-surfacer coating composition 21b used was prepared from a grey pigment paste 21ba that was completed by addition of a blend 21bb consisting of the condensation product of Example 21ac which had been adjusted to a mass fraction of solids of 42% by addition of deionised water, the aqueous dispersion of Example 21ad and a highly methoxymethylated melamine crosslinker.

### Example 21aa

### Acid Functional Polyurethane

In a first reaction, an acid functional polyurethane 21aa was prepared by charging, in a resin kettle, a mixture of 810 g of dimethylolpropionic acid in a mixture of 946 g of diethylene glycol dimethyl ether and 526 g of methyl isobutyl ketone and heating this mixture to 100° C. until complete dissolution. At this temperature, a mixture of 870 g of toluylene diisocyanate (TDI) and 528 g of a semicapped TDI which is a reaction product of one mole of TDI with one mole of ethyleneglycol mono-ethylether was added over four hours while keeping the temperature constant at 100° C. The reaction mixture was stirred at this temperature for one hour in order to complete consumption of all isocyanate groups. The mass fraction of solids was 60%. This acid functional polyurethane 21aa had an acid number of 140 mg KOH/g and a Staudinger-Index of 9.3 cm³/g, measured on solutions in N,N-dimethylformamide (DMF) at 20° C. The semi-capped TDI was prepared separately by addition of 300 g of ethylene glycol mono-ethylether to 580 g of TDI within two hours at 30° C. and subsequent reaction for two more hours after which time a final mass fraction of isocyanate groups in the adduct of 16.5% was found.

### Example 21ab

### Hydroxyl-Functional Polyester

In a separate step, a hydroxyl-functional polyester 21ab was prepared by mixing in a resin kettle, 190 g of tripropylene glycol, 625 g of neopentyl glycol, 140 g of isomerised linoleic acid, 415 g of isophthalic acid, and 290 g of trimellitic acid anhydride, and esterification at 230° C. until the acid number of the reaction mixture had decreased to 4 mg KOH/g. The efflux time of a 50% strength solution in 2-n-butoxyethanol of the resin formed, measured according to DIN 53211 at 20° C., was 165 s. The value of the Staudinger index of the hydroxyfunctional polyester 21ab, measured in N,N-dimethylformamide at 20° C., was 10.5 cm³/g.

### Example 21ac

### Condensation Product 21ac of the Acid Functional Polyurethane of Example 21aa and the Hydroxyl-Functional Polyester of Example 21ab

300 g of the acid functional polyurethane of Example 21aa and 700 g of the hydroxyl-functional polyester of Example 21ab were charged to a reaction vessel equipped with stirrer, thermometer, nitrogen inlet, and distillation apparatus, mixed and heated under stirring to 155° C. The solvents were removed under a nitrogen blanket by distillation under reduced pressure to maintain a steady flow of separated solvent in the condenser. The progress of the reaction was monitored by drawing samples and analyzing for acid number and viscosity. The reaction was stopped when an acid number of 36 mg KOH/g and a Staudinger index of 16.2 cm³/g had been reached, and the condensation product was then cooled to ambient temperature (23° C.) and discharged. This condensation product referred to as 21ac was fully dilutable in water after neutralization with dimethylethanolamine, with no sedimentation or phase separation.

### Example 21ad

### Modified Polyester

A resin kettle equipped with stirrer and reflux condenser was charged with 192 g of tri-propylene glycol and 104 g of neopentyl glycol, the charge was heated under stirring to 110° C. 192 g of trimellitic anhydride were then added, and the mixture was heated within two hours to 170° C. The reaction mixture was held at that temperature until the acid number was 87 mg KOH/g. After cooling to 150° C., 40 g of a commercial mixture of glycidyl esters of alpha-branched decanoic acids (CARDURA® E 10, Momentive Specialty Chemicals, Inc.) and 14 g of linseed oil fatty acid were added. This mixture was then heated to 180° C. within one hour, and held at that temperature until an acid number of 55 mg KOH/g was reached. The reaction mixture was then cooled and diluted by addition of methoxypropanol to a mass fraction of solids of 70%. To 100 g of this solution, 7 g of dimethyl ethanolamine, and 68 g of deionised water were added and homogenized with a mechanical stirrer for fifteen minutes at 600 min⁻¹. An aqueous dispersion with a mass fraction of solids of 40% was obtained.

### Example 21b

### Preparation of the Pigmented Primer-Surfacer Coating Composition

A pigmented primer-surfacer coating composition was prepared according to the following recipe: To 21.10 g of the condensation product of Example 21ac, which had been adjusted to a mass fraction of solids of 42% by addition of deionised water, was charged in the sequence stated: 3.35 g of deionised water, 12.65 g of a rutil-type titanium dioxide pigment (surface treated with Al and Zr compounds, KRONOS® 2190, Kronos Titan GmbH), 12.65 g of precipitated barium sulfate pigment (Blanc fixe F, Sachtleben GmbH), and 0.05 g of carbon 5 black (PRINTEX® U, Evonik Carbon Black GmbH), and then homogenised with a mechanical stirrer at 1200 min⁻¹ for fifteen minutes. This pre-blend was transferred to a bead mill and ground at a temperature not exceeding 50° C. After a milling time of forty-five minutes, the required particle size of 10 μm was achieved, grinding was stopped and the paste referred to as 21ba thus formed was separated from the beads.

A mixture 21bb was prepared by charging 9.00 g of the condensation product of Example 21ac which had been adjusted to a mass fraction of solids of 42% by addition of deionised water, and adding in this sequence, 27.20 g of the aqueous dispersion of Example 21ad, 1.75 g of a highly methoxymethylated melamine crosslinker having a molar ratio of methoxy groups to methylene groups to melamine derived moieties of from 5.0 mole: 5.8 mole: 1 mole (CYMEL® 303, Allnex USA Inc.), and 12 g of deionised water.

This mixture 21bb was added to the paste 21ba at ambient temperature (23° C.) and homogenized with a mechanical stirrer at 1200 min⁻¹ for fifteen minutes to obtain the pigmented primer-surfacer coating composition 21b. Dynamic viscosity of this coating composition 21b was 300 mPa·s (measured at a shear rate of 25 s⁻¹) and its pH value was 8.0.

### Example 22

### Preparation of Base Coating Compositions

Basecoat coating compositions were prepared from the polyurethane-vinyl polymer hybrid dispersions of Examples 1c and the Comparative Examples 1c, 3c and 5, according to the recipe in Table 4:

TABLE 4

| constituent | L1 | L2 | L3 | L4 | |
|---|---|---|---|---|---|
| Example 1C | 254.4 | — | — | — | Part A |
| Comp. Ex. 1C | — | 260.7 | — | — | |
| Comp. Ex. 3C | — | — | 279.1 | — | |
| Comp. Ex. 5 | — | — | — | 253.9 | |
| CYMEL ^{®} 327 | 15.6 | 15.6 | 15.6 | 15.6 | |
| DMEA 10% in water | 14.4 | 14.4 | 14.4 | 14.4 | |
| H₂O deionized | 115.2 | 115.2 | 115.2 | 115.2 | |
| RHEOVIS ^{®} AS 1130 | 87.4 | 87.4 | 87.4 | 87.4 | Part B |
| 10% in water | | | | | |
| H₂O deionized | 227.9 | 227.9 | 227.9 | 227.9 | |
| Aluminum flakes | 93.6 | 93.6 | 93.6 | 93.6 | Part C |
| (HYDROLAN ^{®} 2154) | | | | | |
| ADDITOL ^{®} XL 250 | 6 | 6 | 6 | 6 | |
| Butyl glycol | 69.2 | 69.2 | 69.2 | 69.2 | |
| Isobutanol | 19.5 | 19.5 | 19.5 | 19.5 | Part D |

A Basecoat composition was prepared according to the following recipe: to the polyurethane-vinyl polymer hybrid dispersion (Ex. 1c, Comp. Ex. 1c, Comp. Ex. 3c and Comp. Ex. 5) was charged, in the sequence stated: a methylated high imino melamine crosslinker (CYMEL® 327, allnex Inc.), dimethyl ethanolamine (a 10% strength solution in deionized water) and deionized water (Part A) and then homogenized with a mechanical stirrer at 900 min⁻¹. After fifteen minutes stirring, a 10% strength solution of an acrylic copolymer thickener in deionized water (RHEOVIS®AS 1130, BASF AG) and further deionized water (Part B) were added and homogenized for another 10 minutes at 900 min⁻¹. The aluminum flake slurry (Part C) was prepared in a separate step by charging the aluminum flakes (silica encapsulated aluminium flakes, HYDROLAN® 2154, Eckart GmbH), adding the anionic wetting agent (ADDITOL XL® 250, Allnex GmbH) and butylglycol and homogenizing with a mechanical stirrer at 600 min⁻¹ for 30 minutes. The homogenized Part C was then added with stirring at 900 min¹ to the preblended Part A and B and homogenized for another 20 minutes. In the last step the isobutanol (Part D) is added and homogenized for another 5 minutes at 900 min⁻¹.

The Basecoats prepared as described are allowed to rest for 12 hours at ambient temperature (23° C.). After this resting time, the pH value is adjusted to 8.3 (measured in accordance with DIN ISO 976, at 23° C., on a paint diluted by addition of deionized water having a mass fraction of solids of 10%) by means of a 10% strength solution per weight of dimethyl ethanolamine in deionized water and the viscosity of the paints is adjusted to 300 mPa·s (measured in accordance with DIN EN ISO 3219, at 23° C., and a shear rate of 25 s⁻¹), by adding deionized water.

### Example 23

### Preparation of ClearCoat Coating Composition

### Example 23a

### Hydroxyl-Functional Acrylic Polymer

An acrylic copolymer was made according to the following recipe: Into a reactor equipped with a stirrer, an inert gas inlet, a heating and cooling system and an additional funnel, the glycidylester of neodecanoic acid was charged and heated to 175° C. Within six hours a monomer and initiator mixture was continuously added that consisted of 74.8 g of acrylic acid, 229.3 g of hydroxyethylmethacrylate, 178.3 g of tert-butylmethacrylate, 62.7 g of methylmethacrylate and 222.4 g of styrene together with 19.8 g of di-ter-amyl peroxide and a polymer was formed. The reaction mixture was stirred for two further hours by when more than 95% of conversion were noted. The copolymer was diluted by addition of butyl acetate to as mass fraction of solids of 75%, the solution was filtered after cooling to room temperature to remove suspended solids and the mass fraction of solids was then adjusted to 70% by addition of further butyl acetate.

### Example 23b

### Preparation of the ClearCoat Coating Composition

Two pre-mixtures were prepared according to the following recipes:

### Part A:

825 g hydroxy-functional acrylic polymer Example 23a
51 g Butylacetate
51 g Xylene
51 g Methoxy propylacetate
5 g of a hindered amine light stabilizer (mixture of bis-(1,2,2,6,6-pentamethyl-4-piperidinyl) sebacate and 1-(methyl)-8-(1,2,2,6,6 pentamethyl-4-piperidinyl) sebacate, sold as TINUVIN® 292 by BASF SE
15 g of a benzotrialzole type light stabilizer (mixture of Beta-[3-(2-H-benzotriazole-2-yl)-4-hydroxy-5-tert. butylphenyl] propionic acid poly [ethyleneglycol] 300-ester and bis {Beta-[3-(2-H-benzotriazole-2-yl)-4-hydroxy-5-tert. butylphenyl] propionic acid} poly [ethyleneglycol] 300-ester sold as TINUVIN® 1130, BASF SE)
2 g of a levelling agent based on a modified silicone (ADDITOL® VXL 4930, allnex Austria GmbH)

### Part B:

322 g of HDI trimer dissolved in butylacetate, mass fraction of solution 90% (DESMODUR® N 3390 BA, Isocyanurate type, CAS Nr.: 28182-81-2, sold by Covestro AG)
97 g Butylacetate
40 g Xylene
24 g Solvent naphtha 150/180 (blend of aromatic hydrocarbons with a boiling range of 150-180° C.)

Components of Part A were charged in the order mentioned and homogenized with a mechanical stirrer for 15 minutes at 23° C. (900 min⁻¹).

In a separate step the solution of trimeric HDI and solvents were blended and added with stirring at 900 min⁻¹ to the preblended Part A. After 10 minutes homogenization the viscosity of the clearcoat is adjusted to 130 mPa·s (measured in accordance with DIN EN ISO 3219, at 23° C., and a shear rate of 25 s⁻¹), by adding a mixture in mass ratio of 60/40 of butyl acetate and solvent naphtha 150/180. This ready to use clearcoat coating composition must be applied within 90 minutes.

### Example 24

### Preparation of Multilayer Coatings

A multilayer coating was prepared from the CED coating composition of Example 20, the primer-surfacer coating composition of Example 21b, the basecoat compositions of Example 22 (L1 to L4), and the clearcoat coating composition of Example 23 according to the following procedure.

Preparation of the test panels:
4 Zinc-phosphated steel panels (P1-P4) (GARDOBOND® 26S 6800 OC from Chemetall) were coated with the CED paint according to Example 20 under following conditions:
   temperature of CED-bath: 30° C.
   deposition time: 2 min
   voltage: 300 V
All coated panels were allowed to flash off at ambient temperature for thirty minutes and were then stoved for twenty minutes at 180° C. Dry film thickness of the CED layer was 22 μm for all panels. In the next step the primer surfacer coating composition of Example 21b was applied to all 4 panels (dry film thickness 30 μm) and after a flash off step (10 minutes at 23° C.) stoved for 20 minutes at 165° C. In a third step the 4 panels were overcoated with the basecoat compositions of Example 22 (L1 to L4). The Basecoat layers (10 μm dry film thickness) were allowed to flash off for 10 minutes at 23° C. and were then stoved for 10 minutes at 80° C. Finally all panels were overcoated with the clearcoat composition of Example 23 (50 μm dry film thickness) and stoved for twenty minutes at 140° C.

In Table 5 a detailed overview of the panel preparation is shown.

TABLE 5

| | | | Primer | | | | | |
|---|---|---|---|---|---|---|---|---|
| Panel | CED | Stoving | Surfacer | Stoving | Basecoat | Stoving | Clearcoat | Stoving |
| P1 | Ex. 22 | 20 min; | Ex. 23b | 20 min; | Ex. 24 L1 | 10 min; | Ex. 25 | 20 min; |
| | | 180° C. | | 165° C. | | 80° C. | | 140° C. |
| P2 | Ex. 22 | 20 min; | Ex. 23b | 20 min; | Ex. 24 L2 | 10 min; | Ex. 25 | 20 min; |
| | | 180° C. | | 165° C. | | 80° C. | | 140° C. |
| P3 | Ex. 22 | 20 min; | Ex. 23b | 20 min; | Ex. 24 L3 | 10 min; | Ex. 25 | 20 min; |
| | | 180° C. | | 165° C. | | 80° C. | | 140° C. |
| P4 | Ex. 22 | 20 min; | Ex. 23b | 20 min; | Ex. 24 L4 | 10 min; | Ex. 25 | 20 min; |
| | | 180° C. | | 165° C. | | 80° C. | | 140° C. |

Panels 1 to 4 (P1, P2, P3, P4) were exposed to a humidity resistance testing according to DIN EN ISO 6270-2 (Condensation atmosphere with constant humidity, test duration 240 hours). After the 240 hours, panels were allowed to regenerate for one hour at 23° C. and 65% rel. humidity before the appearance of the panels was evaluated according to DIN EN ISO 4628-2 (Designation of quantity and size of defects, and of intensity of uniform changes in appearance-Part 2: Assessment of degree of blistering).

Results obtained are shown in Table 6.

TABLE 6

| Panel | Degree of blistering |
|---|---|
| P1 | NO blisters |
| P2 | 5 (S1) |
| P3 | 2 (S1) |
| P4 | 5 (S1) |

As appears from Table 6, the comparison clearly shows that the use of a new aqueous polyurethane-vinyl polymer hybrid dispersion according to the present invention, in the basecoat layer of multi-layer coatings, unexpectedly results in a significantly improved water resistance. According to the inventors this unexpected improved water resistance cannot be deduced nor obtained from the state of the art.

1. Aqueous polyurethane-vinyl polymer hybrid dispersion D comprising the reaction product E of from 30 to 80% by weight of one or more ethylenically unsaturated monomer(s) MU2, the MU2 being polymerized in the presence of from 20 to 70% by weight of a polyurethane-vinyl polymer hybrid prepolymer having pendant acid salt groups PUSpp,
the sum of MU2 and PUSpp being 100%;
said polyurethane-vinyl polymer hybrid prepolymer having pendant acid salt groups PUSpp, being in turn the reaction product of:
from 60 to 85% by weight of an acid salt groups comprising hydroxyl-functional polyurethane, PUSoh, having pendant ethylenically unsaturated groups and pendant groups of acid salts; and
from 15 to 40% by weight of one or more ethylenically unsaturated monomer(s) MU1,
the sum of PUSoh and MU1 being 100%,
the MU1 being polymerized in the presence of the acid salt groups comprising hydroxyl-functional polyurethane PUSoh;
said acid salt groups comprising hydroxyl-functional polyurethane, PUSoh, being in turn the reaction product of:
hydroxyl-functional polyurethane PUoh, and
one or more compound(s) An being able to react with an acid group to form salt groups;
said hydroxyl-functional polyurethane PUoh being in turn the reaction product of from 30 to 50% by weight of one or more polyisocyanate(s) I and:
optionally from 1 to 4% by weight of one or more monomeric isocyanate-reactive compound(s) Moh having at least two isocyanate-reactive groups;
from 30 to 40% by weight of one or more polymeric isocyanate reactive compounds Poh having at least two isocyanate-reactive groups;
from 7 to 11% by weight of one or more isocyanate-reactive monomer(s), MAoh, having at least two isocyanate-reactive groups and at least one acid group or group being able to form an acid when contacted with water;
1 from 0.5 to 4% by weight of one or more isocyanate-reactive monomer(s), MUoh, having at least two isocyanate-reactive groups and an ethylenically unsaturated group; and
from 7 to 11% by weight of one or more primary or secondary amine(s), Aoh, having at least one hydroxyl group,
the sum of I, Poh, Moh, MAoh, MUoh and Aoh being 100%.

2. The aqueous polyurethane-vinyl polymer hybrid dispersion D according to claim 1, wherein the hydroxyl-functional polyurethane PUoh is characterized by an unsaturated equivalent weight (UEW) comprised between 3,500 and 35,000 g/equiv., the ethylenically unsaturated groups being pending groups.

3. The aqueous polyurethane-vinyl polymer hybrid dispersion D according to claim 1, wherein the isocyanate-reactive monomers MUoh, having at least two isocyanate-reactive groups and an ethylenically unsaturated group, said MUoh being part of the hydroxyl-functional polyurethane PUoh, are selected from the group consisting of glycerol mono(meth) acrylate, trimethylolpropane mono(meth) acrylate and mixtures thereof.

4. The aqueous polyurethane-vinyl polymer hybrid dispersion D according to claim 1, wherein the hydroxyl-functional polyurethane PUoh is characterized by an acid number between 30 and 60 mg KOH/g; said acid number being generated by the isocyanate-reactive monomers, Maoh, having at least two isocyanate-reactive groups and an at least one acid group or group being able to form an acid when contacted with water, said Maoh being incorporated for at least 95% into the polyurethane through urethane or urea linkages.

5. The aqueous polyurethane-vinyl polymer hybrid dispersion D according to claim 1, wherein the polymeric compounds Poh having at least two isocyanate-reactive groups, said Poh being part of the hydroxyl-functional polyurethane PUoh, are selected from the group consisting of polyesters, polylactones, polyethers, polycarbonates, polyamides, polyenes, polydienes, and mixtures thereof; said polymeric compounds Poh being characterized by a Number Average Molecular Weight comprised between 300 and 10,000 g/mole.

6. The aqueous polyurethane-vinyl polymer hybrid dispersion D according to claim 1, wherein the polymeric compounds Poh having at least two isocyanate-reactive groups, said Poh being part of the hydroxyl-functional polyurethane PUoh, are selected from the group consisting of hydroxyl-functional polyesters, hydroxyl-functional polycarbonates, hydroxyl-functional polyethers and mixtures thereof; said polymeric compounds Poh being characterized by a Number Average Molecular Weight comprised between 500 and 3,000 g/mole.

7. The aqueous polyurethane-vinyl polymer hybrid dispersion D according to claim 1, wherein the polymeric compound Poh having at least two isocyanate-reactive groups is a hydroxyl-functional polyester Poh1, said polyester being the reaction product of a stoichiometric excess of one or more diol(s) and one or more diacid(s), and said polyester being characterized by an hydroxyl number comprised between 40 and 300 mg KOH/g and an acid number of less than 3 mg KOH/g, said acid number being residual and generated by end-standing unreacted acid functionalities.

8. The aqueous polyurethane-vinyl polymer hybrid dispersion D according to claim 1, wherein the one or more ethylenically unsaturated monomer(s) MU1 and/or MU2 is (are) selected from the group consisting of alkyl(meth)acrylate,(meth)acrylamides, hydroxy(meth)acrylates, epoxy-functional (meth)acrylates, keto-functional (meth)acrylates, vinyl monomers and mixtures thereof;
the alkyl(meth)acrylate being an ester of (meth)acrylic acid with aliphatic linear, branched or cyclic mono-alcohols having from one to twelve carbon atoms in the alkyl group.

9. The aqueous polyurethane-vinyl polymer hybrid dispersion D according to claim 1, wherein the % by weight of each monomer contained in MU1 is different from the % by weight of the corresponding monomer in MU2, the sum of % by weight of all monomers contained in MU1 and in MU2 being 100%.

10. The aqueous polyurethane-vinyl polymer hybrid dispersion D according to claim 1, wherein
the polyurethane-vinyl polymer hybrid prepolymer having pendant acid salt groups, PUSpp, is characterized by a weight ratio of acid salt groups comprising hydroxyl-functional polyurethane PUSoh over vinyl polymer derived from MU1 of more than 1; and
the reaction product E of one or more ethylenically unsaturated monomer(s) MU2, the MU2 being polymerized in the presence of said polyurethane-vinyl polymer hybrid prepolymer having pendant acid salt groups, PUSpp, is characterized by a weight ratio of acid salt groups comprising hydroxyl-functional polyurethane PUSoh over total vinyl polymer derived from MU1 and MU2 of 1 or less than 1.

11. The aqueous polyurethane-vinyl polymer hybrid dispersion D according to claim 1, wherein
the polyurethane-vinyl polymer hybrid prepolymer having pendant acid salt groups, PUSpp, is the reaction product of:
from 65 to 80% by weight, of an acid salt groups comprising hydroxyl-functional polyurethane, PUSoh, having pendant ethylenically unsaturated groups and pendant salt groups; and
from 20 to 35% by weight, of one or more polymerized ethylenically unsaturated monomer(s) MU1;
the sum of PUSoh and MU1 being 100%.

12. The aqueous polyurethane-vinyl polymer hybrid dispersion D according to claim 1, wherein
the acid salt groups comprising hydroxyl-functional polyurethane PUSoh, having pendant ethylenically unsaturated groups and pendant salt groups, is the reaction product of:
from 35 to 45% by weight of one or more polyisocyanate(s) I;
from 33 to 37% by weight of one or more polymeric compound(s) Poh having at least two isocyanate-reactive groups;
from 2 to 3% by weight of one or more monomeric compound(s) Moh having at least two isocyanate-reactive groups;
from 8 to 10% by weight of one or more isocyanate-reactive monomer(s) MAoh having at least two isocyanate-reactive groups and an at least one acid group;
from 1 to 3% by weight of one or more isocyanate-reactive monomer(s) Muoh having at least two isocyanate-reactive groups and an ethylenically unsaturated group; and
from 8 to 10% by weight of one or more primary or secondary amine(s) Aoh having at least one hydroxyl group;
the sum of I, Poh, Moh, Maoh, Muoh and Aoh being 100%;
wherein the acid group of Maoh is further converted in an acid salt through addition of one or more neutralizing compound(s) An.

13. The aqueous polyurethane-vinyl polymer hybrid dispersion D according to claim 1, wherein the reaction product E comprises:
from 40 to 70% by weight, of polymerized ethylenically unsaturated monomers MU2, in
from 30 to 60% by weight, of a polyurethane-vinyl polymer hybrid prepolymer having pendant acid salt groups, PUSpp;
the sum of PUSpp and polymerized MU2 being 100%.

14. The aqueous polyurethane-vinyl polymer hybrid dispersion D according to claim 1, wherein dispersed particles of reaction product E are characterized by a Z-average particle size according to ISO 22412, comprised between 50 and 150 nm.

15. The aqueous polyurethane-vinyl polymer hybrid dispersion D according to claim 1, comprising between 40 and 55% by weight of solids and between 45 and 60% by weight of water.

16. Method for the preparation of the aqueous polyurethane-vinyl polymer hybrid dispersions D according to claim 1, said method comprising the steps of:
a) mixing a polymeric compound Poh having at least two isocyanate-reactive groups, in the presence of one or more isocyanate-reactive monomer(s) MAoh having at least two isocyanate-reactive groups and an acid group or group being able to form an acid when contacted with water, and optionally in the presence of one or more isocyanate-reactive monomer(s) Moh having at least two isocyanate-reactive groups, and heating the mixture to a temperature of at least 60° C. under stirring;
b) continuously adding a sub-stoichiometric quantity of the multifunctional isocyanate I to the mixture of step a), preferably over a time period of from ten minutes to sixty minutes while the temperature is kept in a range of from 60° C. to 150° C., thereby forming a isocyanate-reactive polyurethane prepolymer;
c) adding one or more isocyanate-reactive monomer(s) MUoh having at least two isocyanate-reactive groups and an ethylenically unsaturated group, and optionally one or more isocyanate-reactive monomer(s) Moh having at least two isocyanate-reactive groups, and preferably one or more ethylenically unsaturated monomer(s) MU1, to the isocyanate-reactive polyurethane prepolymer of step b), and homogenizing the mixture, optionally in the presence of an antioxidant or radical scavenger;
d) adding a further amount of multifunctional isocyanate I, while stirring at a temperature in the range of from 60° C. to 100° C., to the homogenized mixture of step c) in stoichiometric excess thereby forming an isocyanate-functional polyurethane prepolymer;
e) fast adding a mixture comprising one or more primary or secondary amine(s) Aoh having at least one hydroxyl group, and preferably one or more ethylenically unsaturated monomer(s) MU1, to the isocyanate-functional polyurethane prepolymer of step d) thereby forming an hydroxyl-functional polyurethane PUoh in ethylenically unsaturated monomer(s) MU1;
f) adding neutralizing agent An to the mixture of step e) and homogenizing said mixture for at least 5 minutes at a temperature in the range of from 40°° C. to 80° C. thereby forming an acid salt groups comprising hydroxyl-functional polyurethane, PUSoh, in ethylenically unsaturated monomer(s) MU1;
g) adding water to the homogenized mixture of step f) thereby forming an emulsion;
h) homogenizing the emulsion of step g) at a temperature in the range of from 40° C. to 80° C. for at least 10 minutes;
i) redox-polymerizing the homogenized emulsion of step h) by gradually adding at least one of the redox system components over at least 10 minutes while maintaining the temperature in the range of from 60° C. to 80° C.° C. thereby forming the polymerization mixture;
j) maintaining the temperature of the polymerization mixture at a temperature comprised between 65 and 85° C. for at least 15 minutes, for further polymerizing thereby forming the polyurethane-vinyl polymer hybrid prepolymer having pendant acid salt groups, PUSpp;
k) fast adding a mixture of ethylenically unsaturated monomers MU2 to the polyurethane-vinyl polymer hybrid prepolymer having pendant acid salt groups, PUSpp, of step j) and homogenizing the mixture at a temperature in the range of from 40° C. to 80° C. during at least 10 minutes;
l) redox-polymerizing the homogenized emulsion of step k) by gradually adding at least one of the redox system components over at least 10 minutes while maintaining the temperature in the range of from 60° C. to 80° C.° C. thereby forming the polymerization mixture;
m) maintaining the temperature in the range of from 60° C. to 80° C. for at least 15 minutes to finalize the polymerization, thereby forming the aqueous polyurethane-vinyl polymer hybrid dispersion D1.

17. The method according to claim 16 comprising the additional steps of:
a) fast adding a mixture of ethylenically unsaturated monomers MU2 to the aqueous polyurethane-vinyl polymer hybrid dispersion D1 of step m) and homogenizing the mixture at a temperature in the range of from 40° C. to 80° C. during at least 10 minutes;
b) redox-polymerizing the homogenized emulsion of step n) by gradually adding at least one of the redox system components over at least 10 minutes while maintaining the temperature in the range of from 60° C. to 80° C.° C. thereby forming the polymerization mixture;
c) maintaining the temperature in the range of from 60° C. to 80° C. for at least 15 minutes to finalize the polymerization, thereby forming the aqueous polyurethane-vinyl polymer hybrid dispersion D2.

18. The method according to claim 16, wherein the one or more primary or secondary amine(s) Aoh having at least one hydroxyl group are selected from the group consisting of 2-aminoethanol, 2-methylaminoethanol, 3-aminopropanol, 2-amino-1,3-propanediol, diethanolamine, 1,1′-iminodi-2-propanol and mixtures thereof.

19. A coating composition comprising the aqueous polyurethane-vinyl polymer hybrid dispersion D according to claim 1 and one or more additive(s) selected from the group consisting of defoamers, levelling agents, UV-absorbers, coalescing agents, flow modifiers, rheology additives, crosslinkers, fillers, pigments, active pigments and wetting agents.

20. A coating composition according to claim 19, wherein the crosslinker is added to the aqueous polyurethane-vinyl hybrid polymer dispersion D during its synthesis.

21. Use of the coating composition according to claim 19, for coating a metal, wood, plastic or paper substrate.

22. Corrosion preventing coating comprising the coating composition according to claim 19.

23. Corrosion preventing coating according to claim 22 for use on a metal substrate or in multi-coat build-ups for metal substrates.
